(19) United States
(12) Patent Application Publication
(10) Pub. No.: US 2013/0027357 A1
(43) Pub. Date: Jan. 31, 2013

(54) TOUCH LOCATING METHOD AND SYSTEM, DISPLAY

(71) Applicants: Ping Liu, Beijing (CN); Xinlin Ye, Beijing (CN); Jianjun Liu, Beijing (CN); Xinbin Liu, Beijing (CN)

(72) Inventors: Ping Liu, Beijing (CN); Xinlin Ye, Beijing (CN); Jianjun Liu, Beijing (CN); Xinbin Liu, Beijing (CN)

(21) Appl. No.: 13/641,433

(22) PCT Filed: Apr. 15, 2011
(86) PCT No.: PCT/CN2011/072848

§ 371 Date: Oct. 15, 2012

(30) Foreign Application Priority Data
Apr. 16, 2010 (CN) 20100152319.8

(51) Int. Cl. G06F 3/042

(52) U.S. Cl. 345/175

(57) ABSTRACT

The present invention relates to a touch positioning method and system as well as a display device. Said touch positioning method is applied to an optical touch screen comprising a touch detection area, two imaging devices, a light source and a reflector, the touch detection area and its mirror image touch detection area with regards to the reflector residing within field of view of each imaging device, the method comprising: obtaining location information of touch objects based on image data of an actual touch object and its mirror image touch object with regards to said reflector acquired by said two imaging devices, said touch objects comprise said actual touch object and virtual touch object; obtaining location information of said actual touch object from the location information of said touch objects based on the mirror image relation between said actual touch object and its mirror image touch object as well as the location information of said touch detection area. The present invention may avoid the presence of “ghost images” during the positioning of more than two touch objects and accurately locate where the touch objects reside.

### FIELD OF THE INVENTION

The present invention relates to the field of photoelectric technology, in particular, to a method and a system of touch positioning as well as a display device.

### BACKGROUND ART

With the wide application of computer technology, a new human-computer interaction technology—touch screen technology—has emerged at the beginning of the 1990s. With this technology, a user can manipulate a computer simply by gently touching pictures or texts on a computer display with an object such as a finger or a pen, thus casting off constraint from keyboard and mouse and providing great convenience for the user. Touching screens that are commonly used include: infrared touch screen, touch screen with camera, surface acoustic wave touch screen and projective-capacitive touch screen.

A touch screen with camera uses two cameras to acquire image data of a touch detection area. The angles between the lines linking the location where a touch object resides with optical centers of the two cameras and the line linking the optical centers of the two cameras can be determined based on location information of the touch object in the image data; and then triangle measuring method is used to calculate the location information of the touch object. In the presence of one touch object, the touch screen with cameras may accurately locate where the touch object resides. However, in the presence of more than two touch objects, “ghost image” appears when the touch screen with cameras calculates location information of the touch objects. At this time, the touch screen with cameras cannot accurately locate where the touch objects reside. In the above, “ghost image” refers to a non-actual touch object.

### SUMMARY OF THE INVENTION

The present invention provides a touch positioning method and system and a display device for accurately locating where touch objects reside during the implementation of positioning more than two touch objects.

The present invention provides a touch positioning method, said method applied to an optical touch screen comprising a touch detection area, two imaging devices, a light source and a reflector, said touch detection area and its mirror image touch detection area with regards to said reflector residing within field of view of each imaging device, said method comprising:

obtaining location information of touch objects based on image data of an actual touch object and a mirror image touch object of said actual touch object with regards to said reflector acquired by said two imaging devices, said touch objects including said actual touch object and virtual touch object;

obtaining location information of said actual touch object from the location information of said touch objects based on the mirror image relation between said actual touch object and its mirror image touch object as well as the location information of said touch detection area.

The present invention further provides a touch positioning system, comprising:

an optical touch screen comprising a touch detection area, two imaging devices, a light source and a reflector, said touch detection area and its mirror image touch detection area with regards to said reflector residing within field of view of each imaging device;

a touch object location information acquisition module for obtaining location information of touch objects based on image data of an actual touch object and its mirror image touch object with regards to said reflector acquired by said two imaging devices, said touch objects including said actual touch object and virtual touch object;

an actual touch object location information acquisition module for obtaining location information of said actual touch object from the location information of said touch objects based on the mirror image relation between said actual touch object and its mirror image touch object as well as the location information of said touch detection area.

The present invention further provides a display device comprising a display unit, further comprising the above mentioned touch positioning system.

In the present embodiment, a processing unit obtains location information of touch objects based on image data of an actual touch object and its mirror image touch object with regards to a reflector acquired by two imaging devices, and then, the processing unit obtains location information of the actual touch object from the location information of the touch objects based on the mirror image relation between the actual touch object and its mirror image touch object, so as to avoid the presence of “ghost images” during the positioning of more than two touch objects and accurately locate where the touch objects reside.

### BRIEF DESCRIPTION OF THE DRAWINGS

FIG. 1 is a structural schematic diagram showing an optical touch screen in a first embodiment of the touch positioning method of the present invention;

FIG. 2 is a flow schematic diagram showing a first embodiment of the touch positioning method of the present invention;

FIG. 3 is a flow schematic diagram showing a second embodiment of the touch positioning method of the present invention;

FIG. 4 is a schematic diagram showing the working process of an optical touch screen in the second embodiment of the touch positioning method of the present invention;

FIG. 5 is a flow schematic diagram showing a third embodiment of the touch positioning method of the present invention;

FIG. 6 is a flow schematic diagram showing a fourth embodiment of the touch positioning method of the present invention;

FIG. 7 is a schematic diagram showing the working process of an optical touch screen in the fourth embodiment of the touch positioning method of the present invention;

FIG. 8 is a flow schematic diagram showing a fifth embodiment of the touch positioning method of the present invention;

FIG. 9 is a flow schematic diagram showing a sixth embodiment of the touch positioning method of the present invention;

FIG. 10 is a schematic diagram showing the working process of an optical touch screen in the sixth embodiment of the touch positioning method of the present invention;

FIG. 11 is a flow schematic diagram showing a seventh embodiment of the touch positioning method of the present invention;

FIG. 12 is a structural schematic diagram showing a first embodiment of the touch positioning system of the present invention;

FIG. 13 is a structural schematic diagram showing a second embodiment of the touch positioning system of the present invention;

FIG. 14 is a structural schematic diagram showing a third embodiment of the touch positioning system of the present invention;

FIG. 15 is a structural schematic diagram showing a fourth embodiment of the touch positioning system of the present invention;

FIG. 16 is a structural schematic diagram showing a fifth embodiment of the touch positioning system of the present invention;

FIG. 17 is a structural schematic diagram showing a sixth embodiment of the touch positioning system of the present invention;

FIG. 18 is a structural schematic diagram showing a seventh embodiment of the touch positioning system of the present invention;

FIG. 19 is a structural schematic diagram showing an embodiment of the display device of the present invention.

### DETAILED DESCRIPTION OF THE PREFERRED EMBODIMENTS

The present invention is further described as follows in combination with the figures of the description and the preferred embodiments.

### A First Embodiment of the Touch Positioning Method

The present embodiment is applied to an optical touch screen comprising a touch detection area, two imaging devices, a light source and a reflector, the touch detection area and its mirror image detection area with regards to the reflector residing within field of view of each imaging device.

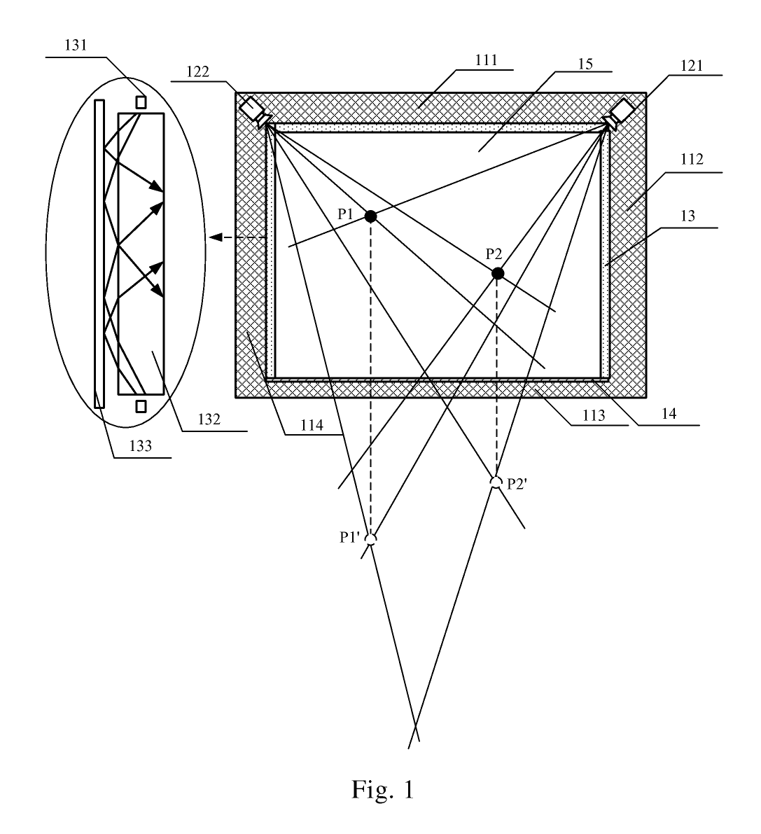

A specific structure of an optical touch object is described as follows. As shown in FIG. 1, which is a structural schematic diagram of an optical touch screen in the first embodiment of the touch positioning method of the present invention, the optical touch screen comprises a touch screen frame, a touch detection area 15, two imaging devices, a light source 13, a reflector 14 and a processing unit (not shown). The touch screen frame comprises a first edge 111, a second edge 112, a third edge 113 and a fourth edge 114. There is touch detection area 15 within the touch screen frame. The two imaging devices include a first imaging device 121 and a second imaging device 122, the first imaging device 121 being mounted at an intersection angle between the first edge 111 and the second edge 112, and the second imaging device 122 being mounted at an intersection angle between the first edge 11 and the fourth edge 114. The reflector 14 is mounted on the third edge 113, and the light source 13 is mounted on the first edge 111, the second edge 112 and the fourth edge 114.

Each of the fields of view of the first imaging device 121 and the second imaging device 122 covers the whole touch detection area 15 and its mirror image detection area with regards to the reflector 14, a reflecting surface of the reflector 14 facing towards the first edge 111.

A specific structure of the light source 13 is described as follows by taking the light source 13 mounted on the fourth edge 114 as an example. Referring to FIG. 1 again, a detailed structural diagram of the light source 13 is shown in the elliptic frame, in which the light source 13 comprises a light emitting body 131, a light conductor 132 and a reflecting panel 133. The light emitting body 131 is located at an end of the light conductor 132, and the reflecting panel 133 is formed within the light conductor 132 at the side far away from the touch detection area 15. The reflecting panel 133 is separated from the light conductor 132. Light from the light emitting body 131 enters into the light conductor 132 and transmits therein. Part of the light transmitted in the light conductor 132 is reflected by the reflecting panel 133 and then emitted from the light conductor 132 and distributed over the touch detection area 15. Meanwhile, part of light transmitted in the light conductor 132 is emitted from the light conductor 132 directly and distributed over the touch detection area 15.

Optionally, the light source 13 may also be a set of infrared emitting tubes with a light emitting surface towards the touch detection area 15.

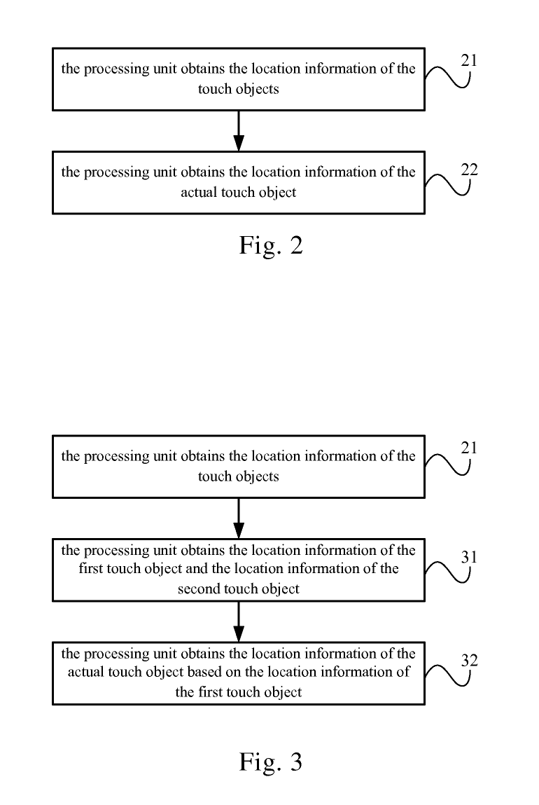

FIG. 2 is a flow schematic diagram of the first embodiment of the touch positioning method of the present invention, which may comprise the following steps:

At step 21, a processing unit obtains location information of touch objects.

Specifically, the processing unit obtains location information of touch objects based on image data of an actual touch object and its mirror image touch object with regards to a reflector acquired by two imaging devices, the touch objects including an actual touch object and a virtual touch object.

In this step, the processing unit may obtain location information of touch objects by adopting the following method. First, the processing unit obtains first direction information and second direction information of an actual touch object as well as first direction information and second direction information of a mirror image touch object of the actual touch object, based on image data of the actual touch object and its mirror image touch object with regards to a reflector acquired by two imaging devices, wherein, the first direction information of the actual touch object includes the direction from the location where the actual touch object resides to an optical center of the first imaging device, the second direction information of the actual touch object includes the direction from the location where the actual touch object resides to an optical center of the second imaging device, the first direction information of the mirror image touch object of the actual touch object includes the direction from the location where the mirror image touch object of the actual touch object relative to optical centers of the first imaging device, and the second direction information of the mirror image touch object of the actual touch object includes the direction from the location where the mirror image touch object of the actual touch object resides to the optical center of the second imaging device. Then, the processing unit obtains the location information of the touch objects by adopting the triangle measuring method, based on the first direction information and second direction information of the actual touch object as well as the first direction information and second direction information of the mirror image touch object of the actual touch object.

In the present embodiment, the first direction information may be, specifically, a first angle, and the second direction information may be, specifically, a second angle. The first angle of a touch object comprises an angle between a line linking the location where the touch object resides with the optical center of the first imaging device and a line linking the optical centers of the two imaging devices, and the second angle of the touch object comprises an angle between a line linking the location where the touch object resides with the optical center of the second imaging device and a line linking the optical centers of the two imaging devices. The first direction information of the mirror image touch object of the touch object with regards to the reflector comprises an angle between a line linking the location where the mirror image touch object of the touch object resides with the optical center of the first imaging device and a line linking the optical centers of the two imaging devices, and the second angle of the mirror image touch object of the touch object comprises an angle between a line linking the location where the mirror image touch object of the touch object resides with the optical center of the second imaging device and a line linking the optical centers of the two imaging devices. Then, a first angle of the actual touch object is an angle between a line linking the location where the actual touch object resides with the optical center of the first imaging device and a line linking the optical centers of the two imaging devices, and a second angle of the actual touch object is an angle between a line linking the location where the actual touch object resides with the optical center of the second imaging device and a line linking the optical centers of the two imaging devices; a first angle of the mirror image touch object of the actual touch object is an angle between a line linking the location where the mirror image touch object of the actual touch object resides with the optical center of the first imaging device and a line linking the optical centers of the two imaging devices, and a second angle of the mirror image touch object of the actual touch object is an angle between a line linking the location where the mirror image touch object of the actual touch object resides with the optical center of the second imaging device and a line linking the optical centers of the two imaging devices. In addition, the triangle measuring method is a prior art, thus it is unnecessary to go into details.

In the present step, supposed that the number of actual touch objects is N, so the number of mirror image touch objects of the actual touch objects is N also. Thus, the processing unit may obtain 2N first angles and 2N second angles; the processing unit obtains location information of 1 touch object based on 1 first angle and 1 second angle, so the processing unit may obtain altogether location information of (2N)2 touch objects, N being a natural number greater than or equal to 1.

At step 22, the processing unit obtains location information of actual touch objects.

Specifically, the processing unit obtains location information of actual touch objects from location information of touch objects, based on the mirror image relation between the actual touch objects and their mirror image touch objects, as well as the location information of the touch detection area.

Working process of the structural schematic diagram shown in FIG. 1 is briefly described below by taking two actual touch objects as an example. Referring to the structural schematic diagram shown in FIG. 1 again, P1 and P2 are two actual touch objects, and P1′ and P2′ are mirror image touch objects of the actual touch objects P1 and P2 with regards to the reflector 14. At step 21, the processing unit obtains a first angle and a second angle of the actual touch object P1, a first angle and a second angle of the actual touch object P2, a first angle and a second angle of the mirror image touch object P1′ of the actual touch object P1 as well as a first angle and a second angle of the mirror image touch object P2′ of the actual touch object P2, based on image data of the actual touch objects P1 and P2 as well as their mirror image touch objects P1′ and P2′ acquired by the first imaging device 121 and the second imaging device 122. Then, the processing unit, based on the first angles and the second angles of the actual touch objects P1 and P2 and the first angles and the second angles of the mirror image touch objects P1′ and P2′ of the actual touch objects P1 and P2, may obtain location information of 16 touch objects, including location information of the actual touch objects P1 and P2 as well as location information of 14 additional virtual touch objects, the location information of the 14 additional virtual touch objects comprising location information of the mirror image touch objects P1′ and P2′ of the actual touch objects P1 and P2. At step 22, the processing unit may obtain the location information of the actual touch objects P1 and P2 from the location information of the 16 touch objects, based on the mirror image relation between the actual touch objects P1 and P2 and their mirror image touch objects P1′ and P2′.

In the present embodiment, the processing unit obtains location information of touch objects based on image data of actual touch objects and their mirror image touch objects with regards to a reflector acquired by two imaging devices, and then, the processing unit obtains location information of the actual touch objects from location information of the touch objects based on the mirror image relation between the actual touch objects and their mirror image touch objects as well as the location information of the touch detection area, so as to avoid the presence of “ghost images” during the positioning of more than two touch objects and accurately locate where the touch objects reside.

### A Second Embodiment of the Touch Positioning Method

FIG. 3 is a flow schematic diagram of the second embodiment of the touch positioning method of the present invention, which differs from the flow schematic diagram shown in FIG. 2 in that step 22 may further comprise the following steps:

At step 31, the processing unit obtains location information of a first touch object and location information of a second touch object.

Specifically, the location information of the touch detection area of the optical touch screen is already known. The processing unit may obtain the location information of the first touch object and the location information of the second touch object from the location information of the touch objects based on the location information of the touch detection area, the first touch object comprising touch objects within the touch detection area of the optical touch screen, the second touch object comprising touch objects outside the touch detection area;

At step 32, the processing unit obtains location information of an actual touch object based on the location information of the first touch object.

Specifically, with respect to each of the first touch object, first, the processing unit may obtain location information of a mirror image touch object of the first touch object with regards to the reflector based on the location information of the first touch object. When the first touch object is an actual touch object, the location information of the second touch object may include the location information of the mirror image touch object of the first touch object with regards to the reflector; when the first touch object is a virtual touch object, the location information of the second touch object does not include the location information of the mirror image touch object of the first touch object with regards to the reflector. Thus the processing unit may compare the location information of the mirror image touch object of the first touch object with the location information of the second touch object, and when the location information of the second touch object includes the location information of the mirror image touch object of the first touch object, the location information of the first touch object is regarded as the location information of the actual touch object.

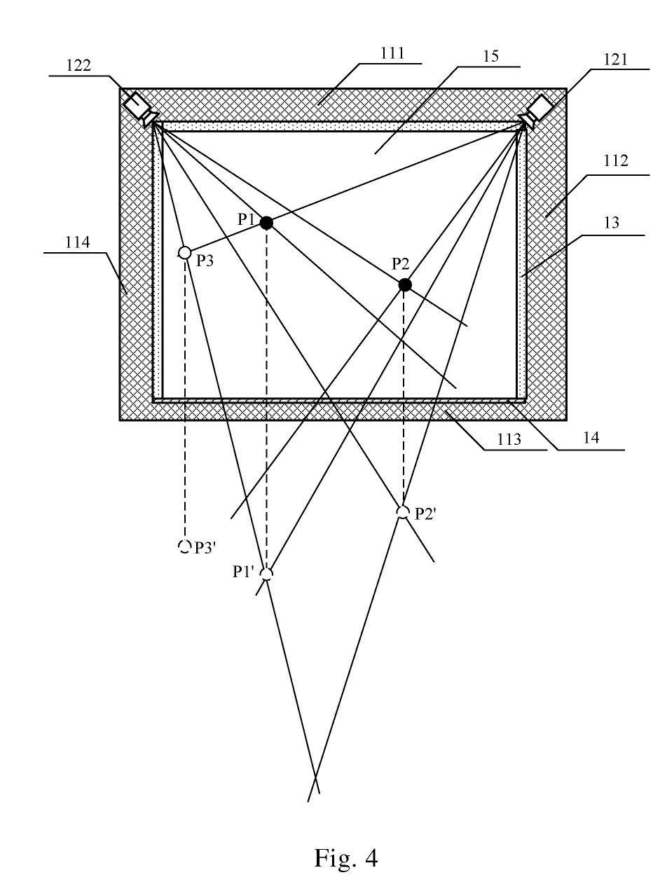

Working process of the present embodiment is briefly described below by taking two actual touch objects as an example. FIG. 4 is a working process diagram of the optical touch screen in the second embodiment of the touch positioning method of the present invention. The structure of the optical touch screen is identical to that shown in the structural schematic diagram in FIG. 1, the working process of the optical touch screen being as follows. At step 21, the processing unit obtains the location information of the touch objects. Since the specific working process of this step is identical to that of step 21 of the preceding embodiment, thus it is unnecessary to go into details. At step 31, the processing unit obtains location information of a first touch object and location information of a second touch object from location information of touch objects. At step 32, with respect to each of the first touch object, for instance, a first touch object P3, first, the processing unit may obtain location information of a mirror image touch object P3′ of the first touch object P3 with regards to the reflector 14 based on location information of the first touch object P3, and then, the processing unit may compare the location information of the mirror image touch object P3′ of the first touch object P3 with the location information of the second touch object. When the location information of the second touch object includes the location information of the mirror image touch object P3′ of the first touch object P3, the first touch object P3 is an actual touch object, and the location information of the first touch object P3 can be regarded as the location information of the actual touch object; when the location information of the second touch object does not include the location information of the mirror image touch object P3′ of the first touch object P3, the first touch object P3 is a virtual touch object. After the processing unit executes step 32 on all the first touch objects, it may obtain location information of all the actual touch objects.

In the present embodiment, first, the processing unit obtains location information of touch objects based on image data of actual touch objects and their mirror image touch objects with regards to a reflector acquired by two imaging devices, and then, the processing unit obtains location information of a first touch object and location information of a second touch object from the location information of the touch objects. With respect to each of the first touch object, the processing unit obtains location information of a mirror image touch object of the first touch object with regards to the reflector based on the location information of the first touch object. When the location information of the second touch object includes the location information of the mirror image touch object of the first touch object, the location information of the first touch object is regarded as location information of the actual touch object, so as to avoid the presence of “ghost images” during the positioning of more than two touch objects and accurately locate where the touch objects reside.

### A Third Embodiment of the Touch Positioning Method

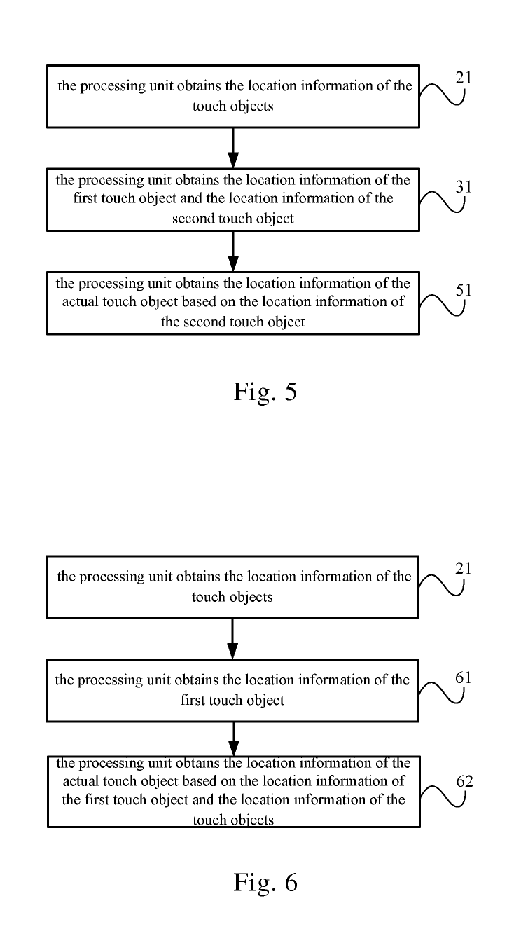

FIG. 5 is a flow schematic diagram of the third embodiment of the touch positioning method of the present invention, which differs from the flow schematic diagram shown in FIG. 3 in that step 32 may have the following steps.

At step 51, the processing unit obtains location information of an actual touch object based on location information of a second touch object.

Specifically, with respect to each of the second touch object, the processing unit obtains location information of a mirror image touch object of the second touch object with regards to the reflector. When the location information of the mirror image touch object of the second touch object with regards to the reflector is an actual touch object, the location information of the first touch object may include the location information of the mirror image touch object of the second touch object; when the location information of the mirror image touch object of the second touch object with regards to the reflector is not an actual touch object, the location information of the first touch object does not include the location information of the mirror image touch object of the second touch object. Thus, the processing unit may compare the location information of the mirror image touch object of the second touch object with the location information of the first touch object, and when the location information of the first touch object includes the location information of the mirror image touch object of the second touch object, the location information of the mirror image touch object of the second touch object can be regarded as the location information of the actual touch object. After the processing unit performs the above processing on all second touch objects, it may obtain location information of all actual touch objects.

Working process of step 51 of the present embodiment is similar to that of step 32 of the preceding embodiment, but differs in that step 32 of the preceding embodiment obtains the actual touch object on the basis that the second touch object may include the mirror image touch object of the actual touch object, while step 51 of the present embodiment obtains the actual touch object on the basis that the first touch object may include the mirror image touch object of the mirror image touch object of the actual touch object.

In the present embodiment, first, the processing unit obtains location information of touch objects based on image data of an actual touch object and its mirror image touch object with regards to the reflector acquired by two imaging devices, and then, the processing unit obtains location information of a first touch object and location information of a second touch object from location information of the touch objects. With respect to each of the second touch object, the processing unit obtains location information of a mirror image touch object of the second touch object with regards to the reflector based on the location information of the second touch object, and compares the location information of the mirror image touch object of the second touch object with the location information of the first touch object. When the location information of the first touch object includes the location information of the mirror image touch object of the second touch object, the location information of the mirror image touch object of the second touch object is regarded as the location information of the actual touch object, so as to avoid the presence of “ghost images” during the positioning of more than two touch objects and accurately locate where the touch objects reside.

### A Fourth Embodiment of the Touch Positioning Method

FIG. 6 is a flow schematic diagram of the fourth embodiment of the touch positioning method of the present invention, which differs from that the flow schematic diagram shown in FIG. 2 in that step 22 may further comprise the following steps.

At step 61, the processing unit obtains location information of a first touch object.

Specifically, the location information of the touch detection area of the optical touch screen is already known, and the processing unit may obtain location information of a first touch object based on the location information of the touch detection area, the first touch object comprising touch objects within the touch detection area of the optical touch screen.

At step 62, the processing unit obtains location information of an actual touch object based on the location information of the first touch object and the location information of the touch objects.

Specifically, with respect to each of the first touch object, the processing unit performs the following processing: obtaining location information of a mirror image touch object of the first touch object with regards to the reflector based on the location information of the first touch object; obtaining first direction information and second direction information of the mirror image touch object of the first touch object based on the location information of the mirror image touch object of the first touch object, the first direction information of the mirror image touch object of the first touch object including the direction from the location where the mirror image touch object of the first touch object resides to the optical center of the first imaging device, and the second direction information of the mirror image touch object of the first touch object including the direction from the location where the mirror image touch object of the first touch object resides to the optical center of the second imaging device; obtaining location information of a third touch object based on the first direction information of the first touch object and the second direction information of the mirror image touch object of the first touch object; obtaining location information of a fourth touch object based on the second direction information of the first touch object and the first direction information of the mirror image touch object of the first touch object; and comparing the location information of the mirror image touch object of the first touch object, the location information of the third touch object, the location information of the fourth touch object with the location information of the touch objects. When the location information of the touch objects includes the location information of the mirror image touch object of the first touch object, the location information of the third touch object and the location information of the fourth touch object, the first touch object is an actual touch object, the location information of which is regarded as the location information of the actual touch object. When the location information of the touch objects does not include the location information of the mirror image touch object of the first touch object, the location information of the third touch object and the location information of the fourth touch object, the first touch object is a virtual touch object. After the processing unit performs the above processing on all the first touch objects, it may obtain location information of all actual touch objects.

In the present embodiment, the first direction information may, specifically, be a first angle, and the second direction information may, specifically, be a second angle; a first angle of the first touch object is an angle between a line linking the location where the first touch object resides with the optical center of the first imaging device and a line linking the optical centers of the two imaging devices, and a second angle of the first touch object is an angle between a line linking the location where the first touch object resides with the optical center of the second imaging device and a line linking the optical centers of the two imaging devices; a first angle of the mirror image touch object of the first touch object is an angle between a line linking the location where the mirror image touch object of the first touch object resides with the optical center of the first imaging device and a line linking the optical centers of the two imaging devices, and a second angle of the mirror image touch object of the first touch object is an angle between the line linking the location where the mirror image touch object of the first touch object resides with the optical center of the second imaging device and a line linking the optical centers of the two imaging devices.

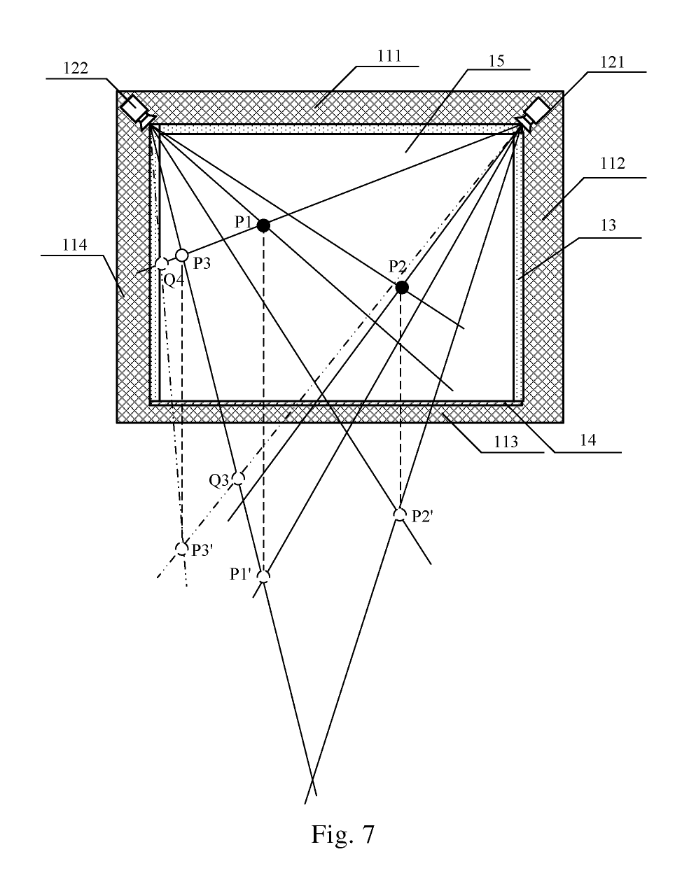

Working process of the present embodiment is described below by taking two actual touch objects as an example. FIG. 7 is a schematic diagram of the working process of the optical touch screen in the fourth embodiment of the touch positioning method of the present invention. The structure of the optical touch screen is identical to the structural schematic diagram shown in FIG. 1. The working process of the present embodiment is as follows. At step 21, the processing unit obtains location information of touch objects. Since the specific working process of this step is identical to that of step 21 of the first embodiment of the touch positioning method, it is unnecessary to go into details. At step 61, the processing unit obtains location information of a first touch object from information location of touch objects. At step 62, with respect to each of the first touch object, for instance, a first touch object P3, the processing unit obtains location information of a mirror image touch object P3′ of the first touch object P3 with regards to the reflector 14 based on location information of the first touch object P3, obtains a first angle and a second angle of the mirror image touch object P3′ of the first touch object P3 based on the location information of the mirror image touch object P3′ of the first touch object P3, obtains location information of a third touch object Q3 based on the first angle of the first touch object P3 and the second angle of the mirror image touch object P3′ of the first touch object P3, obtains location information of a fourth touch object Q4 based on the second angle of the first touch object P3 and the first angle of the mirror image touch object P3′ of the first touch object P3, and compares the location information of the mirror image touch object P3′ of the first touch object P3, the location information of the third touch object Q3 and the location information of the fourth touch object with the location information of the touch objects. When the location information of the touch objects includes the location information of the mirror image touch object of the first touch object P3, the location information of the third touch object Q3 and the location information of the fourth touch object Q4, the location information the first touch object P3 is regarded as the location information of the actual touch object. After the processing unit performs the above processing on all first touch objects, it may obtain location information of all actual touch objects.

In the present embodiment, first, the processing unit obtains location information of touch objects based on image data of an actual touch object and its mirror image touch object with regards to a reflector acquired by two imaging devices, and then, the processing unit obtains location information of a first touch object from the location information of the touch objects. With respect to each of the first touch object, the processing unit obtains location information of a mirror image touch object of the first touch object with regards to the reflector based on the location information of the first touch object, obtains first direction information and second direction information of the mirror image touch object of the first touch object based on the location information of the mirror image touch object of the first touch object, and then obtains the location information of a third touch object and a fourth touch object based on the first and second direction information of the first touch object as well as the first and second direction information of the mirror image touch object of the first touch object. When the location information of the touch objects includes the location information of the mirror image touch object of the first touch object, the location information of the third touch object and the location information of the fourth touch object, the location information of the first touch object is regarded as the location information of the actual touch object, so as to avoid the presence of “ghost images” during the positioning of more than two touch objects and accurately locate where the touch objects reside.

### A Fifth Embodiment of the Touch Positioning Method

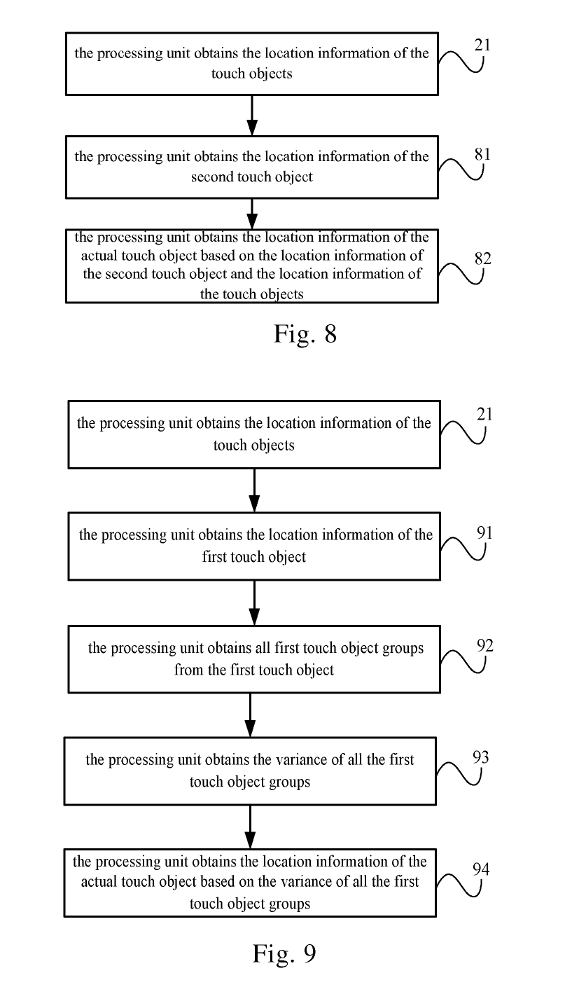

FIG. 8 is a flow schematic diagram of the fifth embodiment of the touch positioning method of the present invention, which differs from the flow schematic diagram shown in FIG. 2 in that step 22 may further comprise the following steps.

At step 81, the processing unit obtains location information of a second touch object.

Specifically, location information of the touch detection area of the optical touch screen is already known, and the processing unit may obtain the location information of the second touch object from the location information of the touch objects based on the location information of the touch detection area, the second touch object comprising touch objects outside the touch detection area of the optical touch screen.

At step 82, the processing unit obtains location information of an actual touch object based on the location information of the second touch object and the location information of the touch objects.

Specifically, with respect to each of the second touch object, the processing unit performs the following processing: obtaining location information of a mirror image touch object of the second touch object with regards to the reflector based on the location information of the second touch object; obtaining first direction information and second direction information of the mirror image touch object of the second touch object based on the location information of the mirror image touch object of the second touch object, the first direction information of the mirror image touch object of the second touch object including directions of a line linking the location where the mirror image touch object of the second touch object resides with the optical center of the first imaging device and a line linking the optical centers of the two imaging devices, the second direction information of the mirror image touch object of the second touch object including directions of a line linking the location where the mirror image touch object of the second touch object resides with the optical center of the second imaging device and a line linking the optical centers of the two imaging devices; obtaining location information of a fifth touch object based on the first direction information of the second touch object and the second direction information of the mirror image touch object of the second touch object; obtaining location information of a sixth touch object based on the second direction information of the second touch object and the first direction information of the mirror image touch object of the second touch object; and comparing the location information of the mirror image touch object of the second touch object, the location information of the fifth touch object, the location information of the sixth touch object with the location information of the touch objects. When the location information of the touch objects includes the location information of the mirror image touch object of the second touch object, the location information of the fifth touch object and the location information of the sixth touch object, the second touch object is a mirror image touch object of an actual touch object, and the location information of the mirror image touch object of the second touch object is regarded as the location information of the actual touch object. When the location information of the touch objects does not include the location information of the mirror image touch object of the second touch object, the location information of the fifth touch object and the location information of the sixth touch object, the second touch object is a virtual touch object rather than the mirror image touch object of the actual touch object.

In the present embodiment, the first direction information may, specifically, be a first angle, and the second direction information may, specifically, be a second angle; a first angle of the second touch object is an angle between a line linking the location where the second touch object resides with the optical center of the first imaging device and a line linking the optical centers of the two imaging devices, and a second angle of the second touch object is an angle between a line linking the location where the second touch object resides with the optical center of the second imaging device and a line linking the optical centers of the two imaging devices; a first angle of the mirror image touch object of the second touch object is an angle between a line linking the location where the mirror image touch object of the second touch object resides with the optical center of the first imaging device and a line linking the optical centers of the two imaging devices, and a second angle of the mirror image touch object of the second touch object is an angle between a line linking the location where the mirror image touch object of the second touch object resides with the optical center of the second imaging device and a line linking the optical centers of the two imaging devices.

The method of the present embodiment is similar to that of the preceding embodiment, but differs in that the present embodiment uses the second touch object outside the touch detection, while the preceding embodiment uses the first touch object within the touch detection area.

In the present embodiment, first, the processing unit obtains location information of touch objects based on image data of an actual touch object and its mirror image touch object with regards to a reflector acquired by two imaging devices, and then, the processing unit obtains location information of a second touch object from location information of touch objects. With respect to each of the second touch object, the processing unit obtains location information of a mirror image touch object of the second touch object with regards to the reflector based on the location information of the second touch object, obtains first direction information and second direction information of the mirror image touch object of the second touch object based on the location information of the mirror image touch object of the second touch object, and then obtains the location information of the fifth and sixth touch objects based on the first direction information and second direction information of the second touch object as well as the first direction information and second direction information of the mirror image touch object of the second touch object. When the location information of the touch objects includes the location information of the mirror image touch object of the second touch object, the location information of the fifth touch object and the location information of the sixth touch object, the location information of the mirror image touch object of the second touch object is regarded as location information of an actual touch object, so as to avoid the presence of “ghost images” during the positioning of more than two touch objects and accurately locate where the touch objects reside.

### A Sixth Embodiment of the Touch Positioning Method

FIG. 9 is a flow schematic diagram of the sixth embodiment of the touch positioning method of the present invention, which differs from the flow schematic diagram shown in FIG. 2 in that step 22 may further comprise the following step.

At step 91, the processing unit obtains location information of a first touch object;

Specifically, the processing unit obtains the location information of the first touch object from location information of touch objects based on the location information of the touch detection area, the first touch object comprising touch objects within the touch detection area of the optical touch screen.

At step 92, the processing unit obtains all the first touch object groups from the first object.

Each of the first touch object group comprises first touch objects with the number of actual touch objects. Supposed that the number of the first touch objects is M which is a natural number greater than or equal to 2, the number of actual touch objects is N which is a natural number is greater than or equal to 2, and N is less than or equal to M, then the number of the first touch object groups is C^{M}_{N}.

At step 93, the processing unit obtains errors of all the first touch object groups.

Specifically, with respect to each of the first touch object group, the processing unit obtains location information of a mirror image touch object of the first touch object with regards to the reflector based on the location information of the first touch object in the first touch object group; obtains first direction information and second direction information of the mirror image touch object of the first touch object based on the location information of the mirror image touch object of the first touch object, the first direction information of the mirror image touch object of the first touch object including the direction from the location where the mirror image touch object of the first touch object resides to the optical center of the first imaging device, the second direction information of the mirror image touch object of the first touch object including the direction from the location where the mirror image touch object of the first touch object resides to the optical center of the second imaging device; obtains location information of a first suspected touch object based on the first direction information and the second direction information of the first touch object as well as the first direction information and the second direction information of the mirror image touch object of the first touch object; obtains the quadratic sum of distances between the first suspected touch object and the touch objects based on the location information of the first suspected touch object and the location information of the touch objects; and regards the quadratic sum of the distances as the error of the first touch object group, wherein the first direction information of the first touch object and the first direction information of the mirror image touch object of the first touch object correspond one by one in order to the first direction information of the actual touch object and the first direction information of the mirror image touch object of the actual touch object, and the second direction information of the first touch object and the second direction information of the mirror image touch object of the first touch object correspond one by one in order to the second direction information of the actual touch object and the second direction information of the mirror image touch object of the actual touch object, so that location information of respective first suspected touch objects and location information of respective touch objects correspond with each other according to the corresponding relation between the first direction information and the second information when obtaining the location information of respective first suspected touch objects and the location information of respective touch objects.

At step 94, the processing unit obtains the location information of the actual touch object based on the errors of all the first touch object groups.

Specifically, the processing unit compares errors of all the first touch object groups, and regards location information of the first touch object in a first touch object group with the minimum error (i.e., the minimum mean squared error) as the location information of the actual touch object.

In the present embodiment, the first direction information may, specifically, be a first angle, and the second direction information may, specifically, be a second angle; a first angle of the first touch object is an angle between a line linking the location where the first touch object resides with the optical center of the first imaging device and a line linking the optical centers of the two imaging devices, and a second angle of the first touch object is an angle between the line linking the location where the first touch object resides with the optical center of the second imaging device and a line linking the optical centers of the two imaging devices; a first angle of the mirror image touch object of the first touch object is an angle between a line linking the location where the mirror image touch object of the first touch object resides with the optical center of the first imaging device and a line linking the optical centers of the two imaging devices, and a second angle of the mirror image touch object of the first touch object is an angle between a line linking the location where the mirror image touch object of the first touch object resides with the optical center of the second imaging device and a line linking the optical centers of the two imaging devices.

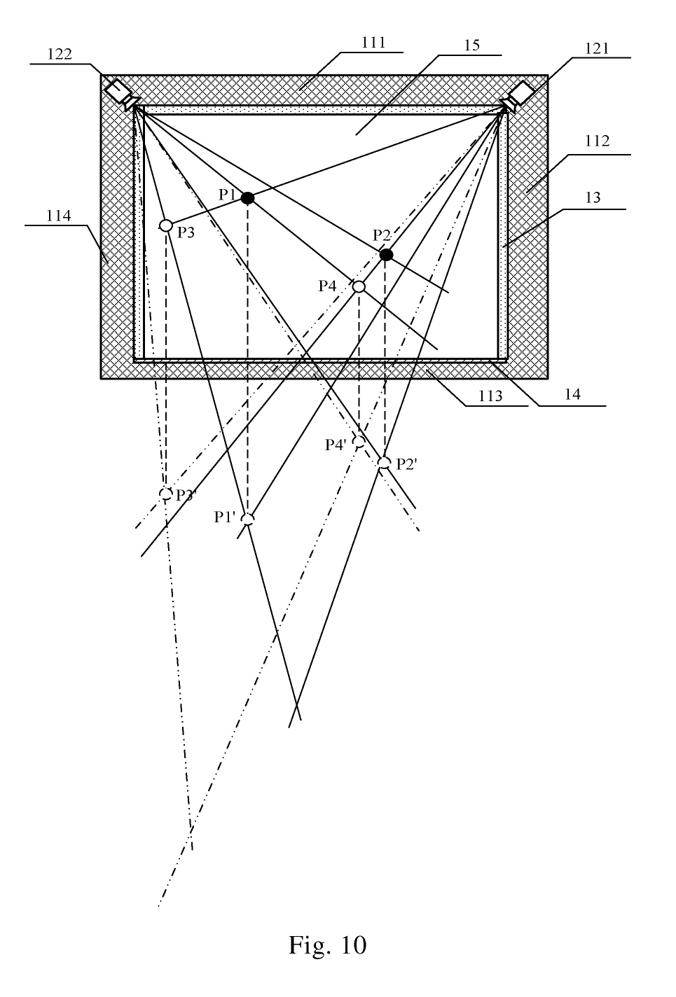

Working process of the present embodiment is described below by taking two actual touch objects as an example. FIG. 10 is a schematic diagram of the working process of the optical touch screen in the sixth embodiment of the touch positioning method of the present invention. The structure of this optical touch screen is identical to that of the optical touch screen shown in FIG. 1, and the working process of this optical touch screen is as follows. At step 21, the processing unit obtains location information of touch objects. Since the specific working process of this step is identical to that of step 21 of the first embodiment of the touch positioning method, it is unnecessary to go into details. At step 91, the processing unit obtains the location information of a first touch object. At step 92, the processing unit obtains all first touch object groups. At step 93, with respect to first touch objects in respective first touch object groups, for instance, first touch objects P3 and P4, whose first angles and second angles have already obtained at step 21, the processing unit obtains location information of mirror image touch objects P3′ and P4′ of the actual touch objects P3 and P4 with regards to the reflector 14, obtains first and second angles of the mirror image P3′ of the first touch object P3 and the first and second angles of the mirror image P4′ of the first touch object P4 based on the location information of the mirror image touch objects P3′ and P4′ of the first touch objects P3 and P4, and then obtains location information of a first suspected touch object based on the first and second angles of the first touch objects P3 and P4 as well as the first and second angles of the mirror image touch objects P3′ and P4′ of the first touch objects P3 and P4, obtains quadratic sum of distances between the first suspected touch object and the touch object, and regards the quadratic sum of the distances as the error of the first touch object group. The first angles of the first touch objects P3 and P4 and the first angles of the mirror image touch objects P3′ and P4′ of the first touch objects P3 and P4 correspond one by one in order to the first angles of the actual touch objects P1 and P2 and the first angles of the mirror image touch objects P1′ and P2′ of the actual touch objects P1 and P2, and the second angles of the first touch objects P3 and P4 and the second angles of the mirror image touch objects P3′ and P4′ of the first touch objects P3 and P4 correspond one by one in order to the second angles of the actual touch objects P1 and P2 and the second angles of the mirror image touch objects P1′ and P2′ of the actual touch objects P1 and P2, so that location information of respective first suspected touch objects and location information of respective touch objects correspond with each other according to the corresponding relation between the first angles and the second angles when obtaining the location information of respective first suspected touch objects and the location information of respective touch objects. At step 94, the processing unit compares errors of all first touch object groups and regards the location information of a first touch object in the first touch object group with the minimum error as the location information of the actual touch object.

In the present embodiment, the processing unit obtains location information of touch objects based on image data of actual touch objects and their mirror image touch objects with regards to a reflector acquired by two imaging devices; the processing unit obtains location information of a first touch object from the location information of the touch objects and obtains all first touch object groups from the first touch object; and then, the processing unit obtains errors of all the first touch object groups; finally, the processing unit compares the errors of all the first touch object groups, and regards location information of a first touch object in the first touch object group with the minimum error as the location information of the actual touch object, so as to avoid the presence of “ghost images” during the positioning of more than two touch objects and accurately locate where the touch objects reside.

### A Seventh Embodiment of the Touch Positioning Method

FIG. 11 is a flow schematic diagram of the seventh embodiment of the touch positioning method of the present invention, which differs from the flow schematic diagram shown in FIG. 2 in that step 22 may further comprise the following steps.

At step 111, the processing unit obtains location information of a second touch object.

Specifically, the processing unit obtains the location information of the second touch object from location information of touch objects based on the location information of the touch detection area, the second touch object comprising touch objects outside the touch detection area.

At step 112, the processing unit obtains all second touch object groups from the second touch object.

Each of the second touch object group comprises second touch objects with the number of actual touch objects.

At step 113, the processing unit obtain errors of all the second touch object groups.

Specifically, with respect to each of the second touch object group, the processing unit obtains location information of a mirror image touch object of the second touch object with regards to the reflector based on the location information of the second touch object in the second touch object group; obtains first direction information and second direction information of the mirror image touch object of the second touch object based on the location information of the mirror image touch object of the second touch object, the first direction information of the mirror image touch object of the second touch object including the direction from the location where the mirror image touch object of the second touch object reside to the optical center of the first imaging device, the second direction information of the mirror image touch object of the second touch object including the direction from the location where the mirror image touch object of the second touch object resides to the optical center of the second imaging device; obtains location information of a second suspected touch object based on the first and second direction information of the second touch object as well as the first and second direction information of the mirror image touch object of the second touch object; obtains the quadratic sum of distances between the second suspected touch object and the touch objects and regards the quadratic sum of the distances as the error of the second touch object group, wherein the first direction information of the second touch object and the first direction information of its mirror image touch object correspond one by one in order to the first direction information of the actual touch object and the first direction information of its mirror image touch object, and the second direction information of the second touch object and the second direction information of its mirror image touch object correspond one by one in order to the second direction information of the actual touch object and the second direction information of its mirror image touch object, so that location information of respective second suspected touch objects and location information of respective touch objects correspond with each other according to the corresponding relation between the first direction information and the second information when obtaining the location information of respective second suspected touch objects and the location information of respective touch objects.

At step 114, the processing unit obtains the location information of the actual touch object based on the errors of all the second touch object groups.

Specifically, the processing unit compares the errors of all the second touch object groups, and regards the location information of a second touch object in the second touch object group with the minimum error (i.e., the minimum mean squared error) as the location information of the actual touch object. The method of the present embodiment is similar to the method of the preceding embodiment, but differs in that the present embodiment uses the second touch object outside the touch detection area, while the preceding embodiment uses the first touch object within the touch detection area.

In the present embodiment, the first direction information may, specifically, be a first angle, and the second direction information may, specifically, be a second angle; a first angle of the second touch object is an angle between a line linking the location where the second touch object resides with the optical center of the first imaging device and a line linking the optical centers of the two imaging devices, and a second angle of the second touch object is an angle between a line linking the location where the second touch object resides with the optical center of the second imaging device and a line linking the optical centers of the two imaging devices; a first angle of the mirror image touch object of the second touch object is an angle between a line linking the location the mirror image touch object of the second touch object resides with the optical center of the first imaging device and a line linking the optical centers of the two imaging devices, and a second angle of the mirror image touch object of the second touch object is an angle between a line linking the location where the mirror image touch object of the second touch object resides with the optical center of the second imaging device and a line linking the optical centers of the two imaging devices.

In the present embodiment, the processing unit obtains location information of touch objects based on image data of an actual touch object and its mirror image touch object with regards to a reflector acquired by two imaging devices; the processing unit obtains location information of a second touch object from the location information of the touch objects and obtains all second touch object groups from the second touch object; and then, the processing unit obtains errors of all the second touch object groups; finally, the processing unit compares the errors of all the second touch object groups, and regards the location information of the mirror image touch object of a second touch object in the second touch object group with the minimum error as the location information of the actual touch object, so as to avoid the presence of “ghost images” during the positioning of more than two touch objects and accurately locate where the touch objects reside.

### A First Embodiment of the Touch Positioning System

FIG. 12 is a structural schematic diagram of the first embodiment of the touch positioning system of the present invention, which may comprise an optical touch screen 1201, a touch object location information acquisition module 1202 and an actual touch object location information acquisition module 1203. The touch object location information acquisition module 1202 is connected to the optical touch screen 1201, and the actual touch object location information acquisition module 1203 is connected to the touch object location information acquisition module 1202.

The optical touch screen 1201 comprises a touch detection area, two imaging devices, a light source and a reflector, the touch detection area and its mirror image touch detection area with regards to the reflector residing within field of view of each imaging device.

The optical touch screen 1201 may further comprise a touch screen frame, the structure of which may refer to FIG. 1, thus it is unnecessary to go into details.

The touch object location information acquisition module 1202 is used for obtaining location information of touch objects based on image data of an actual touch object and its mirror image touch object with regards to the reflector acquired by the two imaging devices, the touch objects including the actual touch object and virtual touch object. The actual touch object location information acquisition module 1203 is used for obtaining location information of the actual touch object from the location information of the touch objects, based on the mirror image relation between the actual touch object and its mirror image touch object as well as the location information of the touch detection area.

Further, in the present embodiment, the touch object location information acquisition module 1202 may comprise a direction acquisition unit 1221 and a touch object location information acquisition unit 1222. The direction acquisition unit 1221 is connected to the two imaging devices of the optical touch screen 1201, and the touch object location information acquisition unit 1222 is connected to the actual touch object location information acquisition module 1203 and the direction acquisition unit 1221.

The direction acquisition unit 1221 is used for obtaining first direction information and second direction information of the actual touch object as well as first direction information and second direction information of the mirror image touch object of the actual touch object based on image data of the actual touch object and its mirror image touch object with regards to the reflector acquired by the two imaging devices, wherein, the first direction information of the actual touch object comprises the direction from the location where the actual touch object resides to the optical center of the first imaging device, the second direction information of the actual touch object comprises the direction from the location where the actual touch object resides to the optical center of the second imaging device, the first direction information of the mirror image touch object of the actual touch object comprises the direction from the location where the mirror image touch object of the actual touch object resides to the optical center of the first imaging device, and the second direction information of the mirror image touch object of the actual touch object comprises the direction from the location where the mirror image touch object of the actual touch object resides to the optical center of the second imaging device. The touch object location information acquisition unit 1222 is used for obtaining the location information of the touch objects based on the first direction information and the second direction information of the actual touch object as well as the first direction information and the second direction information of the mirror image touch object of the actual touch object. Specifically, the touch object location information acquisition unit 1222 may obtain the location information of the touch objects by using the triangle measuring method.

In the present embodiment, the two imaging devices comprise the first imaging device and the second imaging device. The first direction information may be, specifically, a first angle, and the second direction information may be, specifically, a second angle; a first angle of a touch object comprises an angle between a line linking the location where the touch object resides with the optical center of the first imaging device and a line linking the optical centers of the two imaging devices, and a second angle of a touch object comprises an angle between a line linking the location where the touch object resides with the optical center of the second imaging device and a line linking the optical centers of the two imaging devices; the first direction information of the mirror image touch object of the touch object with regards to the reflector comprises an angle between a line linking the location where the mirror image touch object of the touch object resides with the optical center of the first imaging device and a line linking the two optical centers of the two imaging devices, and the second angle of the mirror image touch object of the touch object comprises an angle between a line linking the location where the mirror image touch object of the touch object resides with the optical center of the second imaging device and a line linking the two optical centers of the two imaging devices. Then, a first angle of the actual touch object is an angle between a line linking the location where the actual touch object resides with the optical center of the first imaging device and a line linking the optical centers of the two imaging devices, and a second angle of the actual touch object is an angle between a line linking the location where the actual touch object resides with the optical center of the second imaging device and a line linking the optical centers of the two imaging devices; a first angle of the mirror image touch object of the actual touch object is an angle between a line linking the location where the mirror image touch object of the actual touch object resides with the optical center of the first imaging device and a line linking the optical centers of the two imaging devices, and the second angle of the mirror image touch object of the actual touch object is an angle between a line linking the location where the mirror image touch object of the actual touch object resides with the optical center of the second imaging device and a line linking the optical centers of the two imaging devices.

In the present embodiment, the touch object location information acquisition module 1202 obtains the location information of the touch objects based on the image data of the actual touch object and its mirror image touch object with regards to the reflector acquired by the two imaging devices of the optical touch screen 1201, and then, the actual touch object location information acquisition module 1203 obtains the location information of the actual touch object from the location information of the touch objects based on the mirror image relation between the actual touch object and its mirror image touch object, so as to avoid the presence of “ghost images” during the positioning of more than two touch objects and accurately locate where the touch objects reside.

### A Second Embodiment of the Touch Positioning System

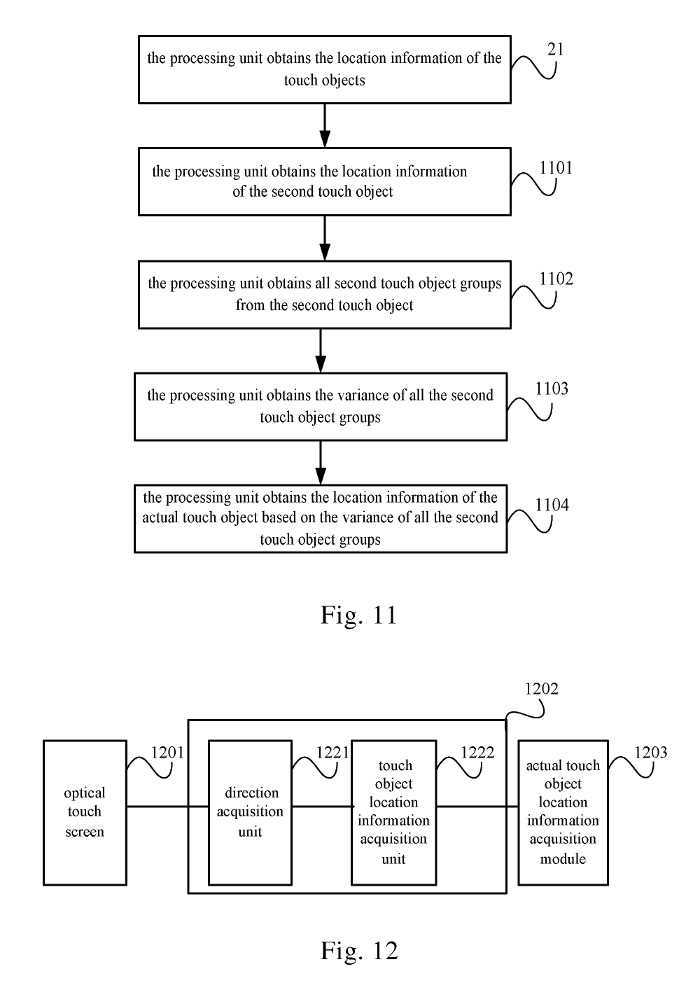

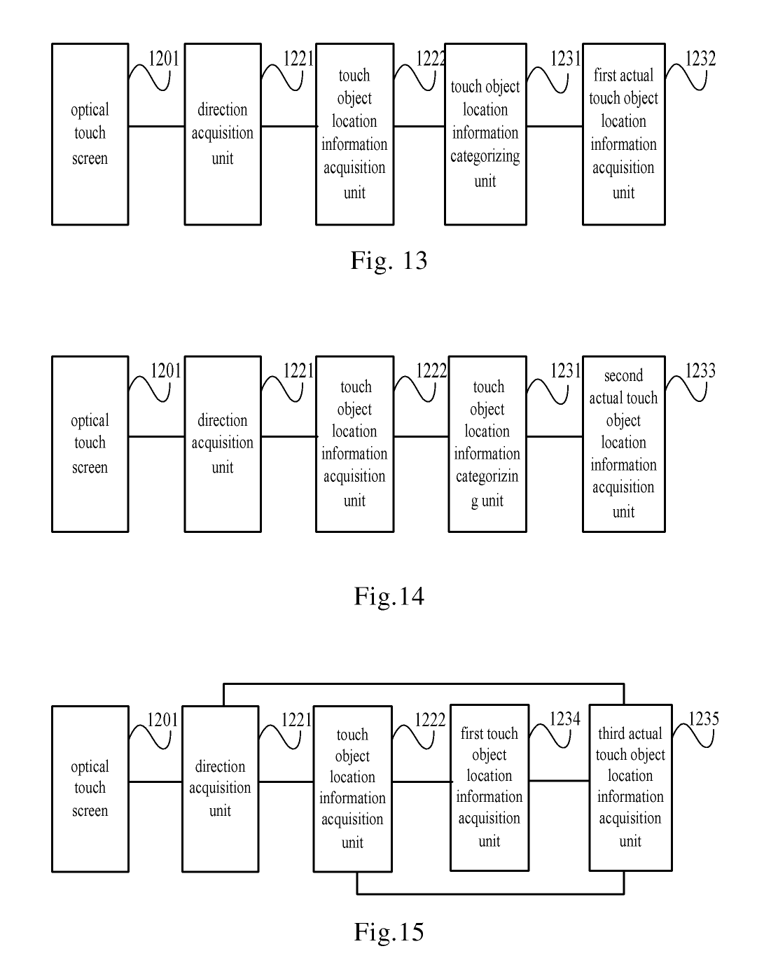

FIG. 13 is a structural schematic diagram of the second embodiment of the touch positioning system of the present invention. On the basis of the structural schematic diagram shown in FIG. 12, the actual touch object location information acquisition module 1203 may further comprise a touch object location information categorizing unit 1231 and a first actual touch object location information acquisition unit 1232. The touch object location information categorizing unit 1231 is connected to the touch object location information acquisition unit 1222, the first actual touch object location information acquisition unit 1232 is connected to the touch object location information categorizing unit 1231.

The touch object location information categorizing unit 1231 is used for obtaining location information of a first touch object and location information of a second touch object from location information of touch objects based on the location information of the touch detection area, the first touch object comprising touch objects within the touch detection area of the optical touch screen, the second touch object comprising touch objects outside the touch detection area. With respect to each of the first touch object, the first actual touch object location information acquisition unit 1232 is used for obtaining location information of a mirror image touch object of the first touch object with regards to the reflector based on the location information of the first touch object, and comparing the location information of the mirror image touch object of the first touch object with the location information of the second touch object. When the location information of the second touch object includes the location information of the mirror image touch object of the first touch object, the location information of the first touch object is regarded as the location information of the actual touch object.

The specific working process of the present embodiment may refer to FIG. 4, and thus it is unnecessary to go into details.

In the present embodiment, the touch object location information acquisition module 1202 obtains the location information of the touch objects based on the image data of the actual touch object and its mirror image touch object with regards to the reflector acquired by the two imaging devices of the optical touch screen 1201; and then, the touch object location information categorizing unit 1231 obtains the location information of the first touch object and the location information of the second touch object from the location information of the touch objects; with respect to each of the first touch object, the first actual touch object location information acquisition unit 1232 obtains the location information of the mirror image touch object of the first touch object with regards to the reflector based on the location information of the first touch object; when the location information of the second touch object includes the location information of the mirror image touch object of the first touch object, the location information of the first touch object is regarded as the location information of the actual touch object; after the first actual touch object location information acquisition unit 1232 processes all first touch objects, it may obtain location information of all actual touch objects, so as to avoid the presence of “ghost images” during the positioning of more than two touch objects and accurately locate where the touch objects reside.

### A Third Embodiment of the Touch Positioning System

FIG. 14 is a structural schematic diagram of the third embodiment of the touch positioning system of the present invention, which differs from the structural schematic diagram shown in FIG. 11 in that the actual touch object location information acquisition module 1203 may comprise a touch object location information categorizing unit 1231 and a second actual touch object location information acquisition unit 1233. The touch object location information categorizing unit 1231 is connected to the touch object location information acquisition unit 1222, while the second actual touch object location information acquisition unit 1233 is connected to the touch object location information categorizing unit 1231.

The touch object location information categorizing unit 1231 is used for obtaining location information of a first touch object and location information of a second touch object from location information of touch objects based on the location information of the touch detection area, the first touch object comprising touch objects within the touch detection area of the optical touch screen, the second touch object comprising touch objects outside the touch detection area. With respect to each of the second touch object, the second actual touch object location information acquisition unit 1233 is used for obtaining location information of a mirror image touch object of the second touch object with regards to the reflector based on the location information of the second touch object, and comparing the location information of the mirror image touch object of the second touch object with the location information of the first touch object. When the location information of the first touch object includes the location information of the mirror image touch object of the second touch object, the location information of the mirror image touch object of the second touch object is regarded as the location information of the actual touch object.

The working process of the present embodiment is similar to that of the preceding embodiment, but differs in that the preceding embodiment obtains the actual touch object on the basis that the second touch object may include the mirror image touch object of the actual touch object, while the present embodiment obtains the actual touch object on the basis that the first touch object may include the mirror image touch object of the mirror image touch object of the actual touch object.

In the present embodiment, the touch object location information acquisition module 1202 obtains the location information of the touch objects based on the image data of the actual touch object and its mirror image touch object with regards to the reflector acquired by the two imaging devices of the optical touch screen 1201; and then, the touch object location information categorizing unit 1231 obtains the location information of the first touch object and the location information of the second touch object from the location information of the touch objects; with respect to each of the second touch object, the second actual touch object location information acquisition unit 1233 obtains the location information of the mirror image touch object of the second touch object with regards to the reflector based on the location information of the second touch object; when the location information of the first touch object includes the location information of the mirror image touch object of the second touch object, the location information of the mirror image touch object of the second touch object is regarded as the location information of the actual touch object; after the second actual touch object location information acquisition unit 1233 processes all second touch objects, it may obtain location information of all actual touch objects, so as to avoid the presence of “ghost images” during the positioning of more than two touch objects and accurately locate where the touch objects reside.

### A Fourth Embodiment of the Touch Positioning System

FIG. 15 is a structural schematic diagram of the fourth embodiment of the touch positioning system of the present invention, which differs from the structural schematic diagram shown in FIG. 12 in that the actual touch object location information acquisition module 1203 may comprise a first touch object location information acquisition unit 1234 and a third actual touch object location information acquisition unit 1235. The first touch object location information acquisition unit 1234 is connected to the touch object location information acquisition unit 1222, while the third actual touch object location information acquisition unit 1235 is connected to the direction acquisition unit 1221, the touch object location information acquisition unit 1222 and the first touch object location information acquisition unit 1234.

The first touch object location information acquisition unit 1234 is used for obtaining location information of a first touch object from location information of touch objects based on the location information of the touch detection area, the first touch object comprising touch objects within the touch detection area of the optical touch screen. With respect to each of the first touch object, the third actual touch object location information acquisition unit 1235 is used for obtaining location information of a mirror image touch object of the first touch object with regards to the reflector based on the location information of the first touch object; obtaining first direction information and second direction information of the mirror image touch object of the first touch object based on the location information of the mirror image touch object of the first touch object, the first direction information of the mirror image touch object of the first touch object comprising the direction from the location where the mirror image touch object of the first touch object resides to the optical center of the first imaging device, the second direction information of the mirror image touch object of the first touch object comprising the direction from the location where the mirror image touch object of the first touch object resides to the optical center of the second imaging device; obtaining location information of a third touch object based on the first direction information of the first touch object as well as the second direction information of the mirror image touch object of the first touch object; obtaining location information of a fourth touch object based on the second direction information of the first touch object and the first direction information of the mirror image touch object of the first touch object; and comparing the location information of the mirror image touch object of the first touch object, the location information of the third touch object and the location information of the fourth touch object with the location information of the touch objects. When the location information of the touch objects includes the location information of the mirror image touch object of the first touch object, the location information of the third touch object and the location information of the fourth touch object, the location information of the first touch object is regarded as the location information of the actual touch object.

In the present embodiment, the first direction information may, specifically, be a first angle, and the second direction information may, specifically, be a second angle; a first angle of the first touch object is an angle between a line linking the location where the first touch object resides with the optical center of the first imaging device and a line linking the optical centers of the two imaging devices, and a second angle of the first touch object is an angle between a line linking the location where the first touch object resides with the optical center of the second imaging device and a line linking the optical centers of the two imaging devices; a first angle of the mirror image touch object of the first touch object is an angle between a line linking the location where the mirror image touch object of the first touch object resides with the optical center of the first imaging device and a line linking the optical centers of the two imaging devices, and a second angle of the mirror image touch object of the first touch object is an angle between a line linking the location where the mirror image touch object of the first touch object resides with the optical center of the second imaging device and a line linking the optical centers of the two imaging devices.

The specific working process of the present embodiment may refer to FIG. 7, and thus it is unnecessary to go into details.

In the present embodiment, the touch object location information acquisition module 1202 obtains the location information of the touch objects based on the image data of the actual touch object and its mirror image touch object with regards to the reflector acquired by the two imaging devices of the optical touch screen 1201; the first touch object location information acquisition unit 1234 obtains the location information of the first touch object from the location information of the touch objects; with respect to each of the first touch object, the third actual touch object location information acquisition unit 1235 obtains at first the location information of the mirror image touch object of the first touch object with regards to the reflector, then obtains the first direction information and the second direction information of the mirror image touch object of the first touch object, and then obtains the location information of the third touch object and the location information of the fourth touch object; when the location information of the touch objects includes the location information of the mirror image touch object of the first touch object, the location information of the third touch object and the location information of the fourth touch object, the location information of the first touch object is regarded as the location information of the actual touch object; after the third actual touch object location information acquisition unit 1235 processes all first touch objects, it may obtain location information of all actual touch objects, so as to avoid the presence of “ghost images” during the positioning of more than two touch objects and accurately locate where the touch objects reside.

### A Fifth Embodiment of the Touch Positioning System

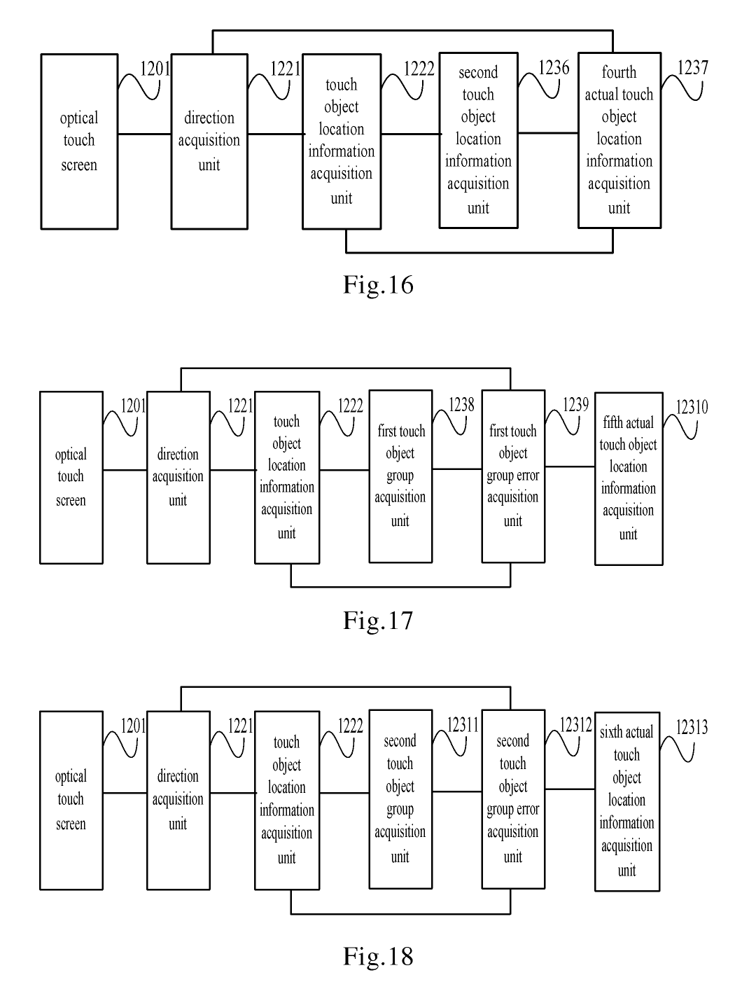

FIG. 16 is a structural schematic diagram of the fifth embodiment of the touch positioning system of the present invention, which differs from the structural schematic diagram shown in FIG. 12 in that in the present embodiment, the actual touch object location information acquisition module 1203 may comprise a second touch object location information acquisition unit 1236 and a fourth actual touch object location information acquisition unit 1237. The second touch object location information acquisition unit 1236 is connected to the touch object location information acquisition unit 1222, and the fourth actual touch object location information acquisition unit 1237 is connected to the direction acquisition unit 1221, the touch object location information acquisition unit 1222 and the second touch object location information acquisition unit 1236.

The second touch object location information acquisition unit 1236 is used for obtaining location information of a second touch object from location information of touch objects based on the location information of the touch detection area, the second touch object comprising touch objects outside the touch detection area. With respect to each of the second touch object, the fourth actual touch object location information acquisition unit 1237 is used for obtaining location information of a mirror image touch object of the second touch object with regards to the reflector based on the location information of the second touch object; obtaining first direction information and second direction information of the mirror image touch object of the second touch object based on the location information of the mirror image touch object of the second touch object, the first direction information of the mirror image touch object of the second touch object comprising the direction from the location where the mirror image touch object of the second touch object resides to the optical center of the first imaging device, the second direction information of the mirror image touch object of the second touch object comprising the direction from the location where the mirror image touch object of the second touch object resides to the optical center of the second imaging device; obtaining location information of a fifth touch object based on the first direction information of the second touch object as well as the second direction information of the mirror image touch object of the second touch object; obtaining location information of a sixth touch object based on the second direction information of the second touch object and the first direction information of the mirror image touch object of the second touch object; and comparing the location information of the mirror image touch object of the second touch object, the location information of the fifth touch object and the location information of the sixth touch object with the location information of the touch objects. When the location information of the touch objects includes the location information of the mirror image touch object of the second touch object, the location information of the fifth touch object and the location information of the sixth touch object, the location information of the mirror image touch object of the second touch object is regarded as the location information of the actual touch object. The working process of the present embodiment is similar to that of the preceding embodiment, but differs in that the present embodiment uses the second touch object outside the touch detection area, while the preceding embodiment uses the first touch object within the touch detection area.

In the present embodiment, the first direction information may, specifically, be a first angle, and the second direction information may, specifically, be a second angle; a first angle of the second touch object is an angle between a line linking the location where the second touch object resides with the optical center of the first imaging device and a line linking the optical centers of the two imaging devices, and a second angle of the second touch object is an angle between a line linking the location where the second touch object resides with the optical center of the second imaging device and a line linking the optical centers of the two imaging devices; a first angle of the mirror image touch object of the second touch object is an angle between a line linking the location where the mirror image touch object of the second touch object resides with the optical center of the first imaging device and a line linking the optical centers of the two imaging devices, and a second angle of the mirror image touch object of the second touch object is an angle between a line linking the location where the mirror image touch object of the second touch object resides with the optical center of the second imaging device and a line linking the optical centers of the two imaging devices.

In the present embodiment, the direction acquisition unit 1221 obtains the first direction information and the second direction information of the actual touch object as well as the first direction information and the second direction information of the mirror image touch object of the actual touch object based on the image data of the actual touch object and its mirror image touch object with regards to the reflector acquired by the two imaging devices of the optical touch screen 1201; the touch object location information acquisition unit 1222 obtains the location information of the touch objects based on the first direction information and the second direction information of the actual touch object as well as the first direction information and the second direction information of the mirror image touch object of the actual touch object; then, the second touch object location information acquisition unit 1236 obtains the location information of the second touch object from the location information of the touch objects; with respect to each of the second touch object, the fourth actual touch object location information acquisition unit 1237 obtains the location information of the mirror image touch object of the second touch object with regards to the reflector based on the location information of the second touch object, obtains the first direction information and the second direction information of the mirror image touch object of the second touch object based on the location information of the mirror image touch object of the second touch object, and then obtains the location information of the fifth touch object and the location information of the sixth touch object; when the location information of the touch objects includes the location information of the mirror image touch object of the second touch object, the location information of the fifth touch object and the location information of the sixth touch object, the location information of the mirror image touch object of the second touch object is regarded as the location information of the actual touch object; after the fourth actual touch object location information acquisition unit 1237 processes all second touch objects, it may obtain location information of all actual touch objects, so as to avoid the presence of “ghost images” during the positioning of more than two touch objects and accurately locate where the touch objects reside.

### A Sixth Embodiment of the Touch Positioning System

FIG. 17 is a structural schematic diagram of the sixth embodiment of the touch positioning system of the present invention. On the basis of the structural schematic diagram shown in FIG. 12, the actual touch object location information acquisition module 1203 may comprise a first touch object group acquisition unit 1238, a first touch object group error acquisition unit 1239 and a fifth actual touch object location information acquisition unit 12310. The first touch object group acquisition unit 1238 is connected to the touch object location information acquisition unit 1222, the first touch object group error acquisition unit 1239 is connected to the first touch object group acquisition unit 1238, the direction acquisition unit 1221 and the touch object location information acquisition unit 1222, and the fifth actual touch object location information acquisition unit 12310 is connected to the first touch object group error acquisition unit 1239.

The first touch object group acquisition unit 1238 is used for obtaining location information of a first touch object from location information of touch objects based on the location information of the touch detection area, the first touch object comprising touch objects within the touch detection area of the optical touch screen; and obtaining a first touch object group from the first touch object, each of the first touch object group comprising first touch objects with the number of actual touch objects. With respect to each of the first touch object group, the first touch object group error acquisition unit 1239 obtains location information of a mirror image touch object of the first touch object with regards to the reflector based on the location information of the first touch object in the first touch object group; obtains first direction information and second direction information of the mirror image touch object of the first touch object based on the location information of the mirror image touch object of the first touch object, the first direction information of the mirror image touch object of the first touch object comprising the direction from the location where the mirror image touch object of the first touch object resides to the optical center of the first imaging device, the second direction information of the mirror image touch object of the first touch object comprising the direction from the location where the mirror image touch object of the first touch object resides to the optical center of the second imaging device; obtains location information of a first suspected touch object based on the first direction information and the second direction information of the first touch object as well as the first direction information and the second direction information of the mirror image touch object of the first touch object; obtains the quadratic sum of distances between the first suspected touch object and the touch objects, and regards the quadratic sum as the error of the first touch object group. The fifth actual touch object location information acquisition unit 12310 is used for comparing errors of all first touch object groups and regarding location information of a first touch object in the first touch object group with the minimum error as the location information of the actual touch object.

In the present embodiment, the first direction information may, specifically, be a first angle, and the second direction information may, specifically, be a second angle; a first angle of the first touch object is an angle between a line linking the location where the first touch object resides with the optical center of the first imaging device and a line linking the optical centers of the two imaging devices, and a second angle of the first touch object is an angle between a line linking the location where the first touch object resides with the optical center of the second imaging device and a line linking the optical centers of the two imaging devices; a first angle of the mirror image touch object of the first touch object is an angle between a line linking the location where the mirror image touch object of the first touch object resides with the optical center of the first imaging device and a line linking the optical centers of the two imaging devices, and a second angle of the mirror image touch object of the first touch object is an angle between a line linking the location where the mirror image touch object of the first touch object resides with the optical center of the second imaging device and a line linking the optical centers of the two imaging devices. The specific working process of the present embodiment may refer to FIG. 10, thus it is unnecessary to go into details.

In the present embodiment, the direction acquisition unit 1221 obtains the first direction information and the second direction information of the actual touch object as well as the first direction information and the second direction information of the mirror image touch object of the actual touch object based on the image data of the actual touch object and its mirror image touch object with regards to the reflector acquired by the two imaging devices of the optical touch screen 1201; the touch object location information acquisition unit 1222 obtains the location information of the touch objects based on the first direction information and the second direction information of the actual touch object as well as the first direction information and the second direction information of the mirror image touch object of the actual touch object; then, the first touch object group acquisition unit 1238 obtains the location information of the first touch object from the location information of the touch objects, and then obtains the first touch object group from the first touch object; the first touch object group error acquisition unit 1239 obtains error of each first touch object group, the fifth actual touch object location information acquisition unit 12310 regards the location information of a first touch object in the first touch object group with the minimum error as the location information of the actual touch object, so as to avoid the presence of “ghost images” during the positioning of more than two touch objects and accurately locate where the touch objects reside.

### A Seventh Embodiment of the Touch Positioning System

FIG. 18 is a structural schematic diagram of the seventh embodiment of the touch positioning system of the present invention. On the basis of the structural schematic diagram shown in FIG. 2, the actual touch object location information acquisition module 1203 may comprise a second touch object group acquisition unit 12311, a second touch object group error acquisition unit 12312 and a sixth actual touch object location information acquisition unit 12313. The second touch object group acquisition unit 12311 is connected to the touch object location information acquisition unit 1222, the second touch object group error acquisition unit 12312 is connected to the second touch object group acquisition unit 12311, the direction acquisition unit 1221 and the touch object location information acquisition unit 1222, and the sixth actual touch object location information acquisition unit 12313 is connected to the second touch object group error acquisition unit 12312.

The second touch object group acquisition unit 12311 is used for obtaining location information of a second touch object from location information of touch objects based on the location information of the touch detection area, the second touch object comprising touch objects outside the touch detection area; and obtaining all second touch object groups from the second touch object, each of the second touch object group comprising second touch objects with the number of actual touch objects. With respect to each of the second touch object group, the second touch object group error acquisition unit 12312 obtains location information of a mirror image touch object of the second touch object with regards to the reflector based on the location information of the second touch object in the second touch object group; obtains first direction information and second direction information of the mirror image touch object of the second touch object based on the location information of the mirror image touch object of the second touch object, the first direction information of the mirror image touch object of the second touch object comprising the direction from the location where the mirror image touch object of the second touch object resides to the optical center of the first imaging device, the second direction information of the mirror image touch object of the second touch object comprising the direction of the location where the mirror image touch object of the second touch object resides to the optical center of the second imaging device; obtains location information of a second suspected touch object based on the first direction information and the second direction information of the second touch object as well as the first direction information and the second direction information of the mirror image touch object of the second touch object; obtains the quadratic sum of distances between the second suspected touch object and the touch objects, and regards the quadratic sum of the distances as the error of the second touch object group. The sixth actual touch object location information acquisition unit 12313 is used for comparing errors of all second touch object groups and regarding the location information of the mirror image touch object of a second touch object in the second touch object group with the minimum error as the location information of the actual touch object.

In the present embodiment, the first direction information may, specifically, be a first angle, and the second direction information may, specifically, be a second angle; a first angle of the second touch object is an angle between a line linking the location where the second touch object resides with the optical center of the first imaging device and a line linking the optical centers of the two imaging devices, and a second angle of the second touch object is an angle between a line linking the location where the second touch object resides with the optical center of the second imaging device and a line linking the optical centers of the two imaging devices; a first angle of the mirror image touch object of the second touch object is an angle between a line linking the location where the mirror image touch object of the second touch object resides with the optical center of the first imaging device and a line linking the optical centers of the two imaging devices, and a second angle of the mirror image touch object of the second touch object is an angle between a line linking the location where the mirror image touch object of the second touch object resides with the optical center of the second imaging device and a line linking the optical centers of the two imaging devices.

In the present embodiment, the direction acquisition unit 1221 obtains the first direction information and the second direction information of the actual touch object as well as the first direction information and the second direction information of the mirror image touch object of the actual touch object based on the image data of the actual touch object and its mirror image touch object with regards to the reflector acquired by the two imaging devices of the optical touch screen 1201; the touch object location information acquisition unit 1222 obtains the location information of the touch objects based on the first direction information and the second direction information o the actual touch object as well as the first direction information and the second direction information of the mirror image touch object of the actual touch object; then, the second touch object group acquisition unit 12311 obtains the location information of the second touch object from the location information of the touch objects, and then obtains all second touch object groups from the second touch object; the second touch object group error acquisition unit 12312 obtains error of each second touch object group, the sixth actual touch object location information acquisition unit 12313 regards the location information of the mirror image touch object of a second touch object in the second touch object group with the minimum error as the location information of the actual touch object, so as to avoid the presence of “ghost images” during the positioning of more than two touch objects and accurately locate where the touch objects reside.

### An Embodiment of a Display Device Comprising the Touch Positioning System

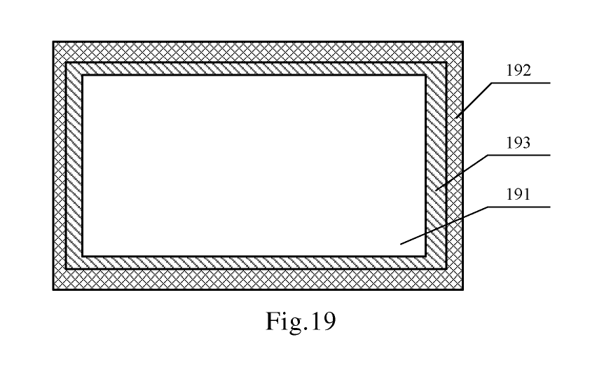

FIG. 19 is a structural schematic diagram of the embodiment of the display device of the present invention, which may comprise a display unit and a touch positioning system 193. The display unit comprises a display screen 191 and a display device frame 192. The touch positioning system 193 is mounted before the display screen 191, at a side closed to a user, and is located within the display device frame 192.

In addition, the touch positioning system 193 may as well be mounted external to the display device frame 192; the touch positioning system 193 may further be mounted in integration with the display device frame 192.

The touch positioning system 193 may comprise any of the modules in the aforementioned embodiments of the touch positioning system, and thus it is unnecessary to go into details.

It needs to be specified that in all the aforementioned embodiments, the imaging devices can be devices for capturing images such as webcams, cameras, etc.

The technical solution of the present invention does not limit to the embodiments described in Detailed Description of the Preferred Embodiments. Other means according to the technical solution of the present invention derived by those skilled in the art likewise belong to the extent of renovation of techniques of the present invention.

1. A touch positioning method, characterized in that said method is applied to an optical touch screen comprising a touch detection area, two imaging devices, a light source and a reflector, said touch detection area and its mirror image touch detection area with regards to said reflector residing within field of view of each imaging device, said method comprising:
obtaining location information of touch objects based on image data of an actual touch object and a mirror image touch object of said actual touch object with regards to said reflector acquired by said two imaging devices, said touch objects including said actual touch object and virtual touch object;
obtaining location information of said actual touch object from the location information of said touch objects based on the mirror image relation between said actual touch object and its mirror image touch object as well as the location information of said touch detection area.

2. The method according to claim 1, characterized in that said obtaining the location information of said actual touch object from the location information of said touch objects based on the mirror image relation between said actual touch object and its mirror image touch object as well as the location information of said touch detection area comprises:
obtaining location information of a first touch object and location information of a second touch object from the location information of said touch objects based on the location information of said touch detection area, said first touch object comprising touch objects within the touch detection area of said optical touch screen, said second touch object comprising touch objects outside said touch detection area;
with respect to each of the first touch object, obtaining location information of a mirror image touch object of said first touch object with regards to said reflector based on the location information of said first touch object, comparing the location information of the mirror image touch object of said first touch object with the location information of said second touch object, and when the location information of said second touch object includes the location information of the mirror image touch object of said first touch object, regarding the location information of said first touch object as the location information of the actual touch object.

3. The method according to claim 1, characterized in that said obtaining the location information of said actual touch object from the location information of said touch objects based on the mirror image relation between said actual touch object and its mirror image touch object as well as the location information of said touch detection area comprises:
obtaining location information of a first touch object and location information of a second touch object from the location information of said touch objects based on the location information of said touch detection area, said first touch object comprising touch objects within the touch detection area of said optical touch screen, said second touch object comprising touch objects outside said touch detection area;
with respect to each of the second touch object, obtaining location information of a mirror image touch object of said second touch object with regards to said reflector based on the location information of said second touch object, comparing the location information of the mirror image touch object of said second touch object with the location information of said first touch object, when the location information of said first touch object includes the location information of the mirror image touch object of said second touch object, regarding the location information of the mirror image touch object of said second touch object as the location information of the actual touch object.

4. The method according to claim 1, characterized in that said two imaging devices comprise a first imaging device and a second imaging device, said obtaining location information of the touch objects based on image data of said actual touch object and its mirror image touch object with regards to said reflector acquired by said two imaging devices comprises:
obtaining first direction information and second direction information of said actual touch object as well as first direction information and second direction information of the mirror image touch object of said actual touch object, based on the image data of said actual touch object and its mirror image touch object with regards to said reflector acquired by said two imaging devices, wherein, the first direction information of said actual touch object includes the direction from the location where said actual touch object resides to an optical center of said first imaging device, the second direction information of said actual touch object includes the direction from the location where said actual touch object resides to an optical center of said second imaging device; the first direction information of the mirror image touch object of said actual touch object includes the direction from the location where the mirror image touch object of said actual touch object resides to the optical center of said first imaging device, the second direction information of the mirror image touch object of said actual touch object includes the direction from the location where the mirror image touch object of said actual touch object resides to the optical center of said second imaging device; obtaining the location information of said touch objects based on the first direction information and the second direction information of said actual touch object as well as the first direction information and the second direction information of the mirror image touch object of said actual touch object.

5. The method according to claim 4, characterized in that said obtaining location information of said actual touch object from the location information of said touch objects based on the mirror image relation between said actual touch object and its mirror image touch object as well as the location information of said touch detection area comprises:
obtaining location information of a first touch object from the location information of said touch objects based on the location information of said touch detection area, said first touch object comprising touch objects residing within the touch detection area of said optical touch screen;
with respect to each of the first touch object, obtaining location information of a mirror image touch object of said first touch object with regards to said reflector based on the location information of said first touch object, obtaining first direction information and second direction information of the mirror image touch object of said first touch object based on the location information of the mirror image touch object of said first touch object, the first direction information of the mirror image touch object of said first touch object including the direction from the location where the mirror image touch object of said first touch object resides to the optical center of said first imaging device, the second direction information of the mirror image touch object of said first touch object including the direction from the location where the mirror image touch object of said first touch object resides to the optical center of said second imaging device, obtaining location information of a third touch object based on the first direction information of said first touch object and the second direction information of the mirror image touch object of said first touch object; obtaining location information of a fourth touch object based on the second direction information of said first touch object and the first direction information of the mirror image touch object of said first touch object; comparing the location information of the mirror image touch object of said first touch object, the location information of said third touch object and the location information of said fourth touch object with the location information of said touch objects, when the location information of said touch objects includes the location information of the mirror image touch object of said first touch object, the location information of said third touch object and the location information of said fourth touch object, regarding the location information of said first touch object as the location information of the actual touch object.

6. The method according to claim 4, characterized in that said obtaining location information of said actual touch object from the location information of said touch objects based on the mirror image relation between said actual touch object and its mirror image touch object as well as the location information of said touch detection area comprises:
obtaining location information of a second touch object from the location information of said touch objects based on the location information of said touch detection area, said second touch object comprising touch objects outside said touch detection area;
with respect to each of the second touch object, obtaining location information of a mirror image touch object of said second touch object with regards to said reflector based on the location information of said second touch object, obtaining first direction information and second direction information of the mirror image touch object of said second touch object based on the location information of the mirror image touch object of said second touch object, the first direction information of the mirror image touch object of said second touch object including the direction from the location where the mirror image touch object of said second touch object resides to the optical center of said first imaging device, the second direction information of the mirror image touch object of said second touch object including the direction from the location where the mirror image touch object of said second touch object resides to the optical center of said second imaging device, obtaining location information of a fifth touch object based on the first direction information of said second touch object and the second direction information of the mirror image touch object of said second touch object, obtaining location information of a sixth touch object based on the second direction information of said second touch object and the first direction information of the mirror image touch object of said second touch object, comparing the location information of the mirror image touch object of said second touch object, the location information of said fifth touch object and the location information of said sixth touch object with the location information of said touch objects, and when the location information of said touch objects includes the location information of the mirror image touch object of said second touch object, the location information of said fifth touch object and the location information of said sixth touch object, regarding the location information of the mirror image touch object of said second touch object as the location information of the actual touch object.

7. The method according to claim 4, characterized in that said obtaining location information of said actual touch object from the location information of said touch objects based on the mirror image relation between said actual touch object and its mirror image touch object as well as the location information of said touch detection area comprises:
obtaining location information of a first touch object from the location information of said touch objects based on the location information of said touch detection area, said first touch object comprising touch objects residing within the touch detection area of said optical touch screen;
obtaining all the first touch object groups from said first touch object, each of the first touch object group comprising first touch objects with the number of actual touch objects;
with respect to each of the first touch object group, obtaining location information of a mirror image touch object of said first touch object with regards to said reflector based on the location information of the first touch object in said first touch object group, obtaining first direction information and second direction information of the mirror image touch object of said first touch object based on the location information of the mirror image touch object of said first touch object, the first direction information of the mirror image touch object of said first touch object including the direction from the location where the mirror image touch object of said first touch object resides to the optical center of said first imaging device, the second direction information of the mirror image touch object of said first touch object including the direction from the location where the mirror image touch object of said first touch object resides to the optical center of said second imaging device, obtaining location information of a first suspected touch object based on the first direction information and the second direction information of said first touch object as well as the first direction information and the second direction information of the mirror image touch object of said first touch object, obtaining a quadratic sum of distances between said first suspected touch object and said touch objects based on the location information of said first suspected touch object and the location information of said touch objects, regarding said quadratic sum of distances as the error of said first touch object group;
comparing errors of all the first touch object groups, and regarding location information of a first touch object in the first touch object group with the minimum error as the location information of said actual touch object.

8. The method according to claim 4, characterized in that said obtaining location information of said actual touch object from the location information of said touch objects based on the mirror image relation between said actual touch object and its mirror image touch object as well as the location information of said touch detection area comprises:
obtaining location information of a second touch object from the location information of said touch objects based on the location information of said touch detection area, said second touch object comprising touch objects outside said touch detection area;
obtaining all the second touch object groups from said second touch object, each of the second touch object group comprising second touch objects with the number of actual touch objects;
with respect to each of the second touch object group, obtaining location information of a mirror image touch object of said second touch object with regards to said reflector based on the location information of the second touch object in said second touch object group, obtaining first direction information and second direction information of the mirror image touch object of said second touch object based on the location information of the mirror image touch object of said second touch object, the first direction information of the mirror image touch object of said second touch object including the direction from the location where the mirror image touch object of said second touch object resides to the optical center of said first imaging device, the second direction information of the mirror image touch object of said second touch object including the direction from the location where the mirror image touch object of the second touch object resides to the optical center of the second imaging device, obtaining location information of a second suspected touch object based on the first direction information and the second direction information of said second touch object as well as the first direction information and the second direction information of the mirror image touch object of said second touch object, obtaining a quadratic sum of distances between said second suspected touch object and said touch objects based on the location information of said second suspected touch object and the location information of said touch objects, regarding said quadratic sum of distances as the error of said second touch object group;
comparing errors of all the second touch object groups, and regarding location information of a mirror image touch object of a second touch object in the second touch object group with the minimum error as the location information of said actual touch object.

9. The method according to any one of claims 4-8, characterized in that said first direction information is specifically a first angle, and said second direction information is specifically a second angle; the first angle of said touch object comprises the angle between the line linking the location where said touch object resides with the optical center of said first imaging device and the line linking the optical centers of said two imaging devices, and the second angle of said touch object comprises the angle between the line linking the location where said touch object resides with the optical center of said second imaging device and the line linking the optical centers of said two imaging devices; the first direction information of the mirror image touch object of said touch object with regards to said reflector comprises the angle between the line linking the location where the mirror image touch object of said touch object resides with the optical center of said first imaging device and the line linking the two optical centers of said two imaging devices, and the second angle of the mirror image touch object of said touch object comprises the angle between the line linking the location where the mirror image touch object of said touch object resides with the optical center of said second imaging device and the line linking the two optical centers of said two imaging devices.

10. A touch positioning system, characterized in that it comprises:
an optical touch screen comprising a touch detection area, two imaging devices, a light source and a reflector, said touch detection area and its mirror image touch detection area with regards to said reflector residing within field of view of each imaging device;
a touch object location information acquisition module for obtaining location information of touch objects based on image data of an actual touch object and its mirror image touch object with regards to said reflector acquired by said two imaging devices, said touch objects including said actual touch object and virtual touch object;
an actual touch object location information acquisition module for obtaining location information of said actual touch object from the location information of said touch objects based on the mirror image relation between said actual touch object and its mirror image touch object as well as the location information of said touch detection area.

11. The system according to claim 10, characterized in that said actual touch object location information acquisition module comprises:
a touch object location information categorizing unit for obtaining location information of a first touch object and location information of a second touch object from the location information of said touch objects based on the location information of said touch detection area, said first touch object comprising touch objects within the touch detection area of said optical touch screen, said second touch object comprising touch objects outside said touch detection area;
a first actual touch object location information acquisition unit for, with respect to each of the first touch object, obtaining location information of a mirror image of said first touch object with regards to said reflector based on the location information of said first touch object, comparing the location information of the mirror image touch object of said first touch object with the location information of said second touch object, and when the location information of said second touch object includes the location information of the mirror image touch object of said first touch object, regarding the location information of said first touch object as the location information of the actual touch object.

12. The system according to claim 10, characterized in that said actual touch object location information acquisition module comprises:
a touch object location information categorizing unit for obtaining location information of a first touch object and location information of a second touch object from location information of touch objects based on the location information of said touch detection area, said first touch object comprising touch objects within the touch detection area of said optical touch screen, said second touch object comprising touch objects outside said touch detection area;
a second actual touch object location information acquisition unit for, with respect to each of the second touch object, obtaining location information of a mirror image of said second touch object with regards to said reflector based on the location information of said second touch object, comparing the location information of the mirror image touch object of said second touch object with the location information of said first touch object, and when the location information of said first touch object includes the location information of the mirror image touch object of said second touch object, regarding the location information of the mirror image touch object of said second touch object as the location information of the actual touch object.

13. The system according to claim 10, characterized in that said two imaging devices comprise a first imaging device and a second imaging device, said touch object location information acquisition module comprises:
a direction acquisition unit for obtaining first direction information and second direction information of said actual touch object as well as first direction information and second direction information of the mirror image touch object of said actual touch object based on image data of said actual touch object and its mirror image touch object with regards to said reflector acquired by said two imaging devices, wherein, the first direction information of said actual touch object comprises the direction from the location where said actual touch object resides to the optical center of said first imaging device, the second direction information of said actual touch object comprises the direction from the location where said actual touch object resides to the optical center of said second imaging device, the first direction information of the mirror image touch object of said actual touch object comprises the direction from the location where the mirror image touch object of said actual touch object resides to the optical center of said first imaging device, and the second direction information of the mirror image touch object of said actual touch object comprises the direction from the location where the mirror image touch object of said actual touch object resides to the optical center of said second imaging device;
a touch object location information acquisition unit for obtaining the location information of said touch objects based on the first direction information and the second direction information of said actual touch object as well as the first direction information and the second direction information of the mirror image touch object of said actual touch object.

14. The system according to claim 13, characterized in that said actual touch object location information acquisition module comprises:
a first touch object location information acquisition unit for obtaining location information of a first touch object from the location information of said touch objects based on the location information of said touch detection area, the first touch object comprising touch objects within the touch detection area of said optical touch screen;
a third actual touch object location information acquisition unit for, with respect to each of the first touch object, obtaining location information of a mirror image touch object of said first touch object with regards to said reflector based on the location information of said first touch object, obtaining first direction information and second direction information of the mirror image touch object of said first touch object based on the location information of the mirror image touch object of said first touch object, the first direction information of the mirror image touch object of said first touch object comprising the direction from the location where the mirror image touch object of said first touch object resides to the optical center of said first imaging device, the second direction information of the mirror image touch object of said first touch object comprising the direction from the location where the mirror image touch object of said first touch object resides to the optical center of said second imaging device, obtaining location information of a third touch object based on the first direction information of said first touch object as well as the second direction information of the mirror image touch object of said first touch object, obtaining location information of a fourth touch object based on the second direction information of said first touch object and the first direction information of the mirror image touch object of said first touch object, comparing the location information of the mirror image touch object of said first touch object, the location information of said third touch object and the location information of said fourth touch object with the location information of said touch objects, and when the location information of said touch objects includes the location information of the mirror image touch object of said first touch object, the location information of said third touch object and the location information of said fourth touch object, regarding the location information of said first touch object as the location information of the actual touch object.

15. The system according to claim 13, characterized in that said actual touch object location information acquisition module comprises:
a second touch object location information acquisition unit for obtaining location information of a second touch object from the location information of said touch objects based on the location information of said touch detection area, said second touch object comprising touch objects outside said touch detection area;
a fourth actual touch object location information acquisition unit connected to said direction acquisition unit and said second touch object location information acquisition unit, and configured for, with respect to each of the second touch object, obtaining location information of a mirror image touch object of said second touch object with regards to said reflector based on the location information of said second touch object, obtaining first direction information and second direction information of the mirror image touch object of said second touch object based on the location information of the mirror image touch object of said second touch object, the first direction information of the mirror image touch object of said second touch object comprising the direction from the location where the mirror image touch object of said second touch object resides to the optical center of said first imaging device, the second direction information of the mirror image touch object of said second touch object comprising the direction from the location where the mirror image touch object of said second touch object resides to the optical center of said second imaging device, obtaining location information of a fifth touch object based on the first direction information of said second touch object as well as the second direction information of the mirror image touch object of said second touch object, obtaining location information of a sixth touch object based on the second direction information of said second touch object and the first direction information of the mirror image touch object of said second touch object; comparing the location information of the mirror image touch object of said second touch object, the location information of said fifth touch object and the location information of said sixth touch object with the location information of said touch objects, and when the location information of said touch objects includes the location information of the mirror image touch object of said second touch object, the location information of said fifth touch object and the location information of said sixth touch object, regarding the location information of the mirror image touch object of said second touch object as the location information of the actual touch object.

16. The system according to claim 13, characterized in that said actual touch object location information acquisition module comprises:
a first touch object group acquisition unit for obtaining location information of a first touch object from the location information of said touch objects based on the location information of said touch detection area, said first touch object comprising touch objects within the touch detection area of said optical touch screen, obtaining a first touch object group from said first touch object, each of the first touch object group comprising first touch objects with the number of said actual touch objects;
a first touch object group error acquisition unit for, with respect to each of the first touch object group, obtaining location information of a mirror image touch object of said first touch object with regards to said reflector based on the location information of the first touch object in said first touch object group, obtaining first direction information and second direction information of the mirror image touch object of said first touch object based on the location information of the mirror image touch object of said first touch object, the first direction information of the mirror image touch object of said first touch object comprising the direction from the location where the mirror image touch object of said first touch object resides to the optical center of said first imaging device, the second direction information of the mirror image touch object of said first touch object comprising the direction from the location where the mirror image touch object of said first touch object resides to the optical center of said second imaging device, obtaining location information of a first suspected touch object based on the first direction information and the second direction information of said first touch object as well as the first direction information and the second direction information of the mirror image touch object of said first touch object, obtaining a quadratic sum of distances between said first suspected touch object and said touch objects based on the location information of the first suspected touch object and the location information of said touch objects, regarding said quadratic sum of distances as the error of said first touch object group;
a fifth actual touch object location information acquisition unit for comparing errors of all the first touch object groups and regarding location information of a first touch object in the first touch object group with the minimum error as the location information of said actual touch object.

17. The system according to claim 13, characterized in that said actual touch object location information acquisition module comprises:
a second touch object group acquisition unit for obtaining location information of a second touch object from the location information of said touch objects based on the location information of said touch detection area, said second touch object comprising touch objects outside the touch detection area, obtaining all second touch object groups from said second touch object, each of the second touch object group comprising second touch objects with the number of actual touch objects;
a second touch object group error acquisition unit for, with respect to each of the second touch object group, obtaining location information of a mirror image touch object of said second touch object with regards to said reflector based on the location information of the second touch object in said second touch object group, obtaining first direction information and second direction information of the mirror image touch object of said second touch object based on the location information of the mirror image touch object of said second touch object, the first direction information of the mirror image touch object of said second touch object comprising the direction from the location where the mirror image touch object of said second touch object resides to the optical center of said first imaging device, the second direction information of the mirror image touch object of said second touch object comprising the direction from the location where the mirror image touch object of said second touch object resides to the optical center of said second imaging device, obtaining location information of a second suspected touch object based on the first direction information and the second direction information of said second touch object as well as the first direction information and the second direction information of the mirror image touch object of said second touch object, obtaining a quadratic sum of distances between said second suspected touch object and said touch objects based on the location information of the second suspected touch object and the location information of said touch objects, regarding said quadratic sum of distances as the error of said second touch object group;
a sixth actual touch object location information acquisition unit for comparing errors of all second touch object groups and regarding location information of a mirror image touch object of a second touch object in the second touch object group with the minimum error as the location information of said actual touch object.

18. The system according to any one of claims 13-17, characterized in that said first direction information is specifically a first angle, and said second direction information is specifically a second angle; the first angle of said touch object comprises the angle between the line linking the location where said touch object resides with the optical center of said first imaging device and the line linking the optical centers of said two imaging devices, and the second angle of said touch object comprises the angle between the line linking the location where said touch object resides with the optical center of said second imaging device and the line linking the optical centers of said two imaging devices; the first direction information of the mirror image touch object of said touch object with regards to said reflector comprises the angle between the line linking the location where the mirror image touch object of said touch object resides with the optical center of said first imaging device and the line linking the two optical centers of said two imaging devices, and the second angle of the mirror image touch object of said touch object comprises the angle between the line linking the location where the mirror image touch object of said touch object resides with the optical center of said second imaging device and the line linking the two optical centers of said two imaging devices.

19. The system according to any one of claims 10-17, characterized in that said optical touch screen further comprises a touch screen frame, said touch screen frame including a first edge, a second edge, a third edge and a fourth edge, said two imaging devices are mounted respectively at an intersection angle between said first edge and said second edge and an intersection angle between said first edge and said fourth edge, said reflector is mounted at said third edge, said light source is mounted at said first edge, second edge and fourth edge.

20. A display device comprising a display unit, characterized in that it further comprises said touch positioning system according to any one of claims 10-19.
